(19) United States
(12) Patent Application Publication
(10) Pub. No.: US 2025/0039414 A1
(43) Pub. Date: Jan. 30, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Zhipin DENG, Beijing (CN); Kai Zhang, Los Angeles, CA (US); Li Zhang, Los Angeles, CA (US)

(21) Appl. No.: 18/915,059

(22) Filed: Oct. 14, 2024

Related U.S. Application Data
(63) Continuation of application No. PCT/CN2023/087683, filed on Apr. 11, 2023.

(30) Foreign Application Priority Data
Apr. 13, 2022 (WO) PCT/CN2022/086715

(51) Int. Cl. H04N 19/186; H04N 19/105; H04N 19/176

(52) U.S. Cl. CPC H04N 19/186; H04N 19/105; H04N 19/176

(57) ABSTRACT

Embodiments of the disclosure provide a solution for video processing. A method for video processing is proposed. The method includes: determining, for a conversion between a video unit of a video and a bitstream of the video, a chroma block of the video unit based on a prediction mode of a luma block of the video unit; and performing the conversion based on the chroma block.

### CROSS-REFERENCE TO RELATED APPLICATIONS

This application is a continuation of International Application No. PCT/CN2023/087683, filed on Apr. 11, 2023, which claims the benefit of International Application No. PCT/CN2022/086715 filed on Apr. 13, 2022. The entire contents of these applications are hereby incorporated by reference in their entireties. FIELDS

Embodiments of the present disclosure relates generally to video processing techniques, and more particularly, to Context Adaptive Variable Length Coding (CABAC) initialization, intra block copy, block vector (BV) list building, and chroma sample reordering in image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a chroma block of the video unit based on a prediction mode of a luma block of the video unit; and performing the conversion based on the chroma block. According to the first aspect of the present disclosure, the coding efficiency can be improved.

In a second aspect, another method for video processing is proposed. The method comprises: generating, a conversion between a video unit of a video and a bitstream of the video, a motion list of the video unit in association with a reordering approach that is applied to the video unit or a neighboring video unit, wherein the neighboring video is coded prior to the video unit; and performing the conversion based on the motion list. According to the first aspect of the present disclosure, the coding efficiency can be improved.

In a third aspect, another method for video processing is proposed. The method comprises: determining, a conversion between a video unit of a video and a bitstream of the video, whether a context initialization probability of a first slice of the video unit is dependent on a further context initialization probability obtained a second slice; obtaining the context initialization probability of the first slice based on the determination; and performing the conversion based on the context initialization probability. According to the first aspect of the present disclosure, the coding efficiency can be improved.

In a fourth aspect, an apparatus for video processing is proposed. The apparatus comprises a processor and a non-transitory memory with instructions thereon. The instructions upon execution by the processor, cause the processor to perform a method in accordance with any of the first aspect, the second aspect, or the third aspect of the present disclosure.

In a fifth aspect, a non-transitory computer-readable storage medium is proposed. The non-transitory computer-readable storage medium stores instructions that cause a processor to perform a method in accordance with any of the first aspect, the second aspect, or the third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining a chroma block of a video unit of the video based on a prediction mode of a luma block of the video unit; and generating a bitstream based on the chroma block.

In a seventh aspect, a method for storing a bitstream of a video is proposed. The method comprises: determining a chroma block of a video unit of the video based on a prediction mode of a luma block of the video unit; generating a bitstream based on the chroma block; and storing the bitstream in a non-transitory computer-readable recording medium.

In an eighth aspect, another non-transitory computer-readable recording medium is proposed. The non-transitory computer-readable recording medium stores a bitstream of a video which is generated by a method performed by an apparatus for video processing. The method comprises: generating a motion list of a video unit of the video in association with a reordering approach that is applied to the video unit or a neighboring video unit, and wherein the neighboring video is coded prior to the video unit; and generating a bitstream based on the motion list.

In a ninth aspect, a method for storing a bitstream of a video is proposed. The method comprises: generating a motion list of a video unit of the video in association with a reordering approach that is applied to the video unit or a neighboring video unit, and wherein the neighboring video is coded prior to the video unit; generating a bitstream based on the motion list; and storing the bitstream in a non-transitory computer-readable recording medium.

In a tenth aspect, another non-transitory computer-readable recording medium is proposed. The non-transitory computer-readable recording medium stores a bitstream of a video which is generated by a method performed by an apparatus for video processing. The method comprises: determining whether a context initialization probability of a first slice of a video unit of the video is dependent on a further context initialization probability obtained a second slice; obtaining the context initialization probability of the first slice based on the determination; and generating the bitstream based on the context initialization probability.

In an eleventh aspect, a method for storing a bitstream of a video is proposed. The method comprises: determining whether a context initialization probability of a first slice of a video unit of the video is dependent on a further context initialization probability obtained a second slice; obtaining the context initialization probability of the first slice based on the determination; generating the bitstream based on the context initialization probability; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of current CTU processing order and its available reference samples in current and left CTU;

FIG. 5 illustrates an example of residual coding passes for transform skip blocks;

FIG. 6 illustrates an example of a block coded in palette mode;

FIG. 7 illustrates an example of subblock-based index map scanning for palette, left for horizontal scanning and right for vertical scanning;

FIG. 8 illustrates an example of decoding flowchart with ACT;

FIG. 9 illustrates an example of intra template matching search area used;

FIG. 10 illustrates a flowchart for decoding a bin;

FIG. 11 illustrates an example of residual coding structure for transform blocks;

FIG. 12 illustrates an example of the template used for selecting probability models, in which black square specifies the current scan position and the grey squares represent the local neighbourhood used;

FIG. 13 illustrates a schematic diagram of a template and reference samples of the template in reference pictures;

FIG. 14 illustrates a schematic diagram of a template and reference samples of the template for block with sub-block motion using the motion information of the subblocks of the current block;

FIG. 15 illustrates an example of clipping an invalid BV candidate to a valid BV candidate;

FIG. 16 illustrates a schematic diagram of a first example of the motion vector adjustment according to neighbor block's motion vector (horizontal flip):

FIG. 17 illustrates a schematic diagram of a second example of the motion vector adjustment according to neighbor block's motion vector (vertical flip);

FIG. 18 illustrates a schematic diagram of a third example of the motion vector adjustment according to neighbor block's motion vector (horizontal flip);

FIG. 19 illustrates a schematic diagram of a fourth example of the motion vector adjustment according to neighbor block's motion vector (vertical flip)

FIG. 20A illustrates a schematic diagram of a first example of sample reordering based template matching;

FIG. 20B illustrates a schematic diagram of a second example of sample reordering based template matching;

FIG. 20C illustrates a schematic diagram of a third example of sample reordering based template matching;

FIG. 20D illustrates a schematic diagram of a fourth example of sample reordering based template matching;

FIG. 20E illustrates a schematic diagram of a fifth example of sample reordering based template matching;

FIG. 20F illustrates a schematic diagram of a sixth example of sample reordering based template matching;

FIG. 20G illustrates a schematic diagram of a seventh example of sample reordering based template matching;

FIG. 20H illustrates a schematic diagram of an eighth example of sample reordering based template matching;

FIG. 21 illustrates a flowchart of a method for video processing in accordance with embodiments of the present disclosure;

FIG. 22 illustrates a flowchart of a method for video processing in accordance with embodiments of the present disclosure;

FIG. 23 illustrates a flowchart of a method for video processing in accordance with embodiments of the present disclosure;

FIG. 24 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

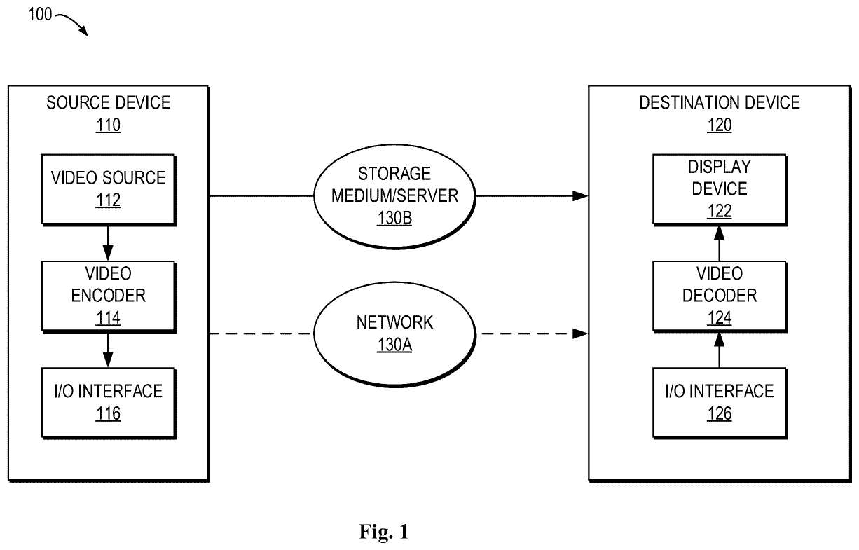

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

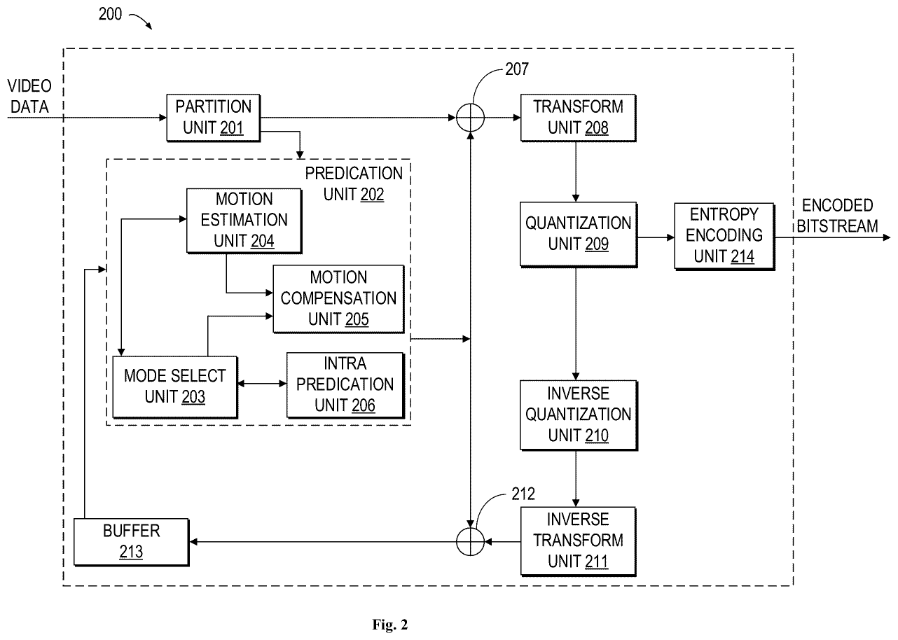

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

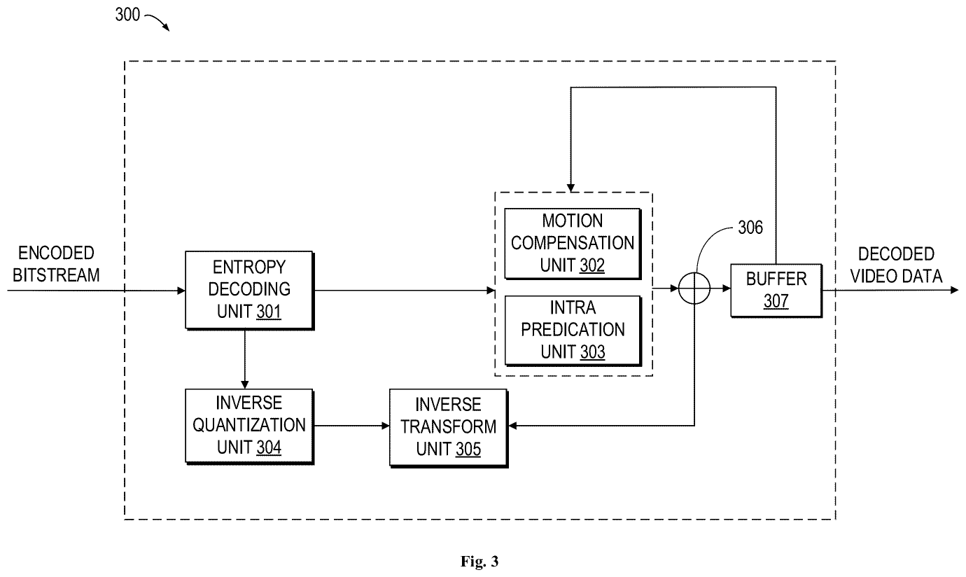

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This present disclosure is related to video coding technologies. Specifically, it is about context/CABAC initialization, intra block copy and/or current picture referencing in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC (High Efficiency Video Coding, Edition 4, Rec. ITU-T H.265, ISO/IEC 23008-2, December 2016) standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM (VTM software: https://vcgit.hhi.fraunhofer.de/jvet/VVCSoftware_VTM.git) are then updated after every meeting. The VVC project achieved technical completion (FDIS) at the July 2020 meeting (Versatile Video Coding, Version 1, Rec. ITU-T H.266, ISO/IEC FDIS 23090-3, July 2020).

### 2.1 Existing Screen Content Coding Tools

### 2.1.1 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.1.1.1 IBC Reference Region

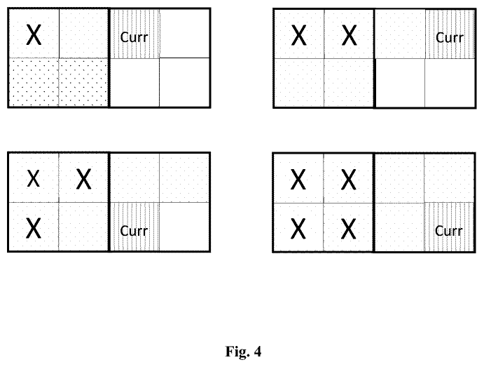

To reduce memory consumption and decoder complexity, the IBC in VVC allows only the reconstructed portion of the predefined area including the region of current CTU and some region of the left CTU. FIG. 4 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.1.1.2 IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min (ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set

ibcBuf[x % wIbcBuf][y % ctbSize]=recSample[x][y].

For a block covering the coordinates (x, y), if the following is true for a block vector bv=(bv[0], bv[1]), then it is valid; otherwise, it is not valid:

$$ibcBuf [ ( x + bv [ 0 ] ) \% wIbcBuf ] [ ( y + bv [ 1 ] ) \% ctbZize ] shall not be equal to - 1.$$

### 2.1.2 Block Differential Pulse Coded Modulation (BDPCM)

VVC supports block differential pulse coded modulation (BDPCM) for screen content coding. At the sequence level, a BDPCM enable flag is signalled in the SPS; this flag is signalled only if the transform skip mode (described in the next section) is enabled in the SPS.

When BDPCM is enabled, a flag is transmitted at the CU level if the CU size is smaller than or equal to MaxTsSize by MaxTsSize in terms of luma samples and if the CU is intra coded, where MaxTsSize is the maximum block size for which the transform skip mode is allowed. This flag indicates whether regular intra coding or BDPCM is used. If BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.

For a block of size M (height)×N (width), let r_{i,j}, 0≤i≥M−1, 0≤j≤N−1 be the prediction residual. Let Q(r_{i,j}), 0≤i≥M−1, 0≤j≤N−1 denote the quantized version of the residual r_{i,j}. BDPCM is applied to the quantized residual values, resulting in a modified M×N array \tilde{R} with elements \tilde{r}_{i,j}, where \tilde{r}_{i,j} is predicted from its neighboring quantized residual value. For vertical BDPCM prediction mode, for 0≤j≤(N−1), the following is used to derive \tilde{r}_{i,j}:

$${\tilde{r}}_{i , j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} . \qquad ( 2 - 1 )$$

For horizontal BDPCM prediction mode, for 0≤i≥(M−1), the following is used to derive \tilde{r}_{i,j}:

$${\tilde{r}}_{i , j} = \{ \begin{matrix}Q ( {r}_{i , j} ) , & j = 0 \\ Q ( {r}_{i , j} ) - Q ( {r}_{i , ( j - 1 )} ) , & 1 \leq j \leq ( N - 1 )\end{matrix} . \qquad ( 2 - 2 )$$

At the decoder side, the above process is reversed to compute Q(r_{i,j}), 0≤i≤M−1, 0≤j≤N−1, as follows:

$$Q ( {r}_{i , j} ) = {\sum }_{k = 0}^{i} {\tilde{r}}_{k , j} , if vertical BDPCM is used , \qquad ( 2 - 3 )$$

$$Q ( {r}_{i , j} ) = {\sum }_{k = 0}^{j} {\tilde{r}}_{i , k} , if horizontal BDPCM is used . \qquad ( 2 - 4 )$$

The inverse quantized residuals, Q⁻¹(Q(r_{i,j})), are added to the intra block prediction values to produce the reconstructed sample values.

The predicted quantized residual values \tilde{r}_{i,j} are sent to the decoder using the same residual coding process as that in transform skip mode residual coding. For lossless coding, if slice_ts_residual_coding_disabled_flag is set to 1, the quantized residual values are sent to the decoder using regular transform residual coding as described in 2.2.2. In terms of the MPM mode for future intra mode coding, horizontal or vertical prediction mode is stored for a BDPCM-coded CU if the BDPCM prediction direction is horizontal or vertical, respectively. For deblocking, if both blocks on the sides of a block boundary are coded using BDPCM, then that particular block boundary is not deblocked.

### 2.1.3 Residual Coding for Transform Skip Mode

VVC allows the transform skip mode to be used for luma blocks of size up to MaxTsSize by MaxTsSize, where the value of MaxTsSize is signaled in the PPS and can be at most 32. When a CU is coded in transform skip mode, its prediction residual is quantized and coded using the transform skip residual coding process. This process is modified from the transform coefficient coding process described in 2.2.2. In transform skip mode, the residuals of a TU are also coded in units of non-overlapped subblocks of size 4×4. For better coding efficiency, some modifications are made to customize the residual coding process towards the residual signal's characteristics. The following summarizes the differences between transform skip residual coding and regular transform residual coding:
Forward scanning order is applied to scan the subblocks within a transform block and also the positions within a subblock;
no signalling of the last (x, y) position;
coded_sub_block_flag is coded for every subblock except for the last subblock when all previous flags are equal to 0;
sig_coeff_flag context modelling uses a reduced template, and context model of sig_coeff_flag depends on top and left neighbouring values;
context model of abs_level_gt1 flag also depends on the left and top sig_coeff_flag values;
par_level_flag using only one context model;
additional greater than 3, 5, 7, 9 flags are signalled to indicate the coefficient level, one context for each flag;
rice parameter derivation using fixed order=1 for the binarization of the remainder values;
context model of the sign flag is determined based on left and above neighbouring values and the sign flag is parsed after sig_coeff_flag to keep all context coded bins together.

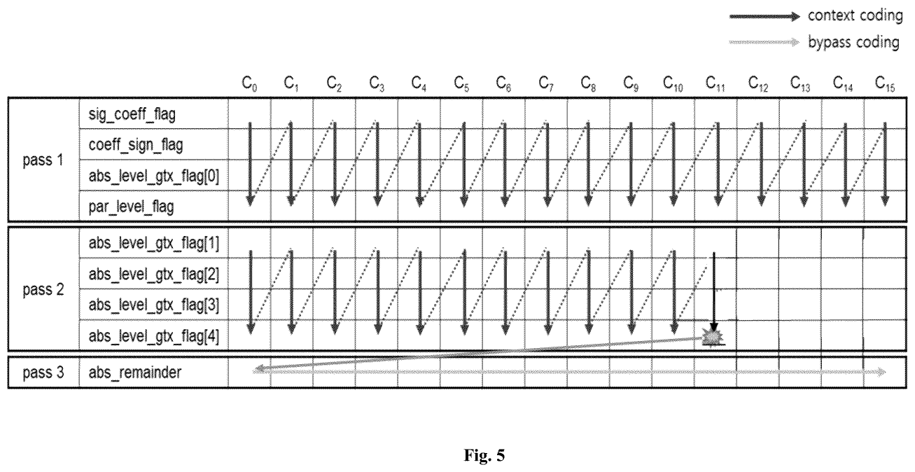

For each subblock, if the coded_subblock_flag is equal to 1 (i.e., there is at least one non-zero quantized residual in the subblock), coding of the quantized residual levels is performed in three scan passes (see FIG. 5):
First scan pass: significance flag (sig_coeff_flag), sign flag (coeff_sign_flag), absolute level greater than 1 flag (abs_level_gtx_flag[0]), and parity (par_level_flag) are coded. For a given scan position, if sig_coeff_flag is equal to 1, then coeff_sign_flag is coded, followed by the abs_level_gtx_flag[0] (which specifies whether the absolute level is greater than 1). If abs_level_gtx_flag[0] is equal to 1, then the par_level_flag is additionally coded to specify the parity of the absolute level.
Greater-than-x scan pass: for each scan position whose absolute level is greater than 1, up to four abs_level_gtx_flag[i] for i=1 . . . 4 are coded to indicate if the absolute level at the given position is greater than 3, 5, 7, or 9, respectively.
Remainder scan pass: The remainder of the absolute level abs_remainder are coded in bypass mode. The remainder of the absolute levels are binarized using a fixed rice parameter value of 1.

The bins in scan passes #1 and #2 (the first scan pass and the greater-than-x scan pass) are context coded until the maximum number of context coded bins in the TU have been exhausted. The maximum number of context coded bins in a residual block is limited to 1.75*block_width*block_height, or equivalently, 1.75 context coded bins per sample position on average. The bins in the last scan pass (the remainder scan pass) are bypass coded. A variable, RemCcbs, is first set to the maximum number of context-coded bins for the block and is decreased by one each time a context-coded bin is coded. While RemCcbs is larger than or equal to four, syntax elements in the first coding pass, which includes the sig_coeff_flag, coeff_sign_flag, abs_level_gt1_flag and par_level_flag, are coded using context-coded bins. If RemCcbs becomes smaller than 4 while coding the first pass, the remaining coefficients that have yet to be coded in the first pass are coded in the remainder scan pass (pass #3).

After completion of first pass coding, if RemCcbs is larger than or equal to four, syntax elements in the second coding pass, which includes abs_level_gt3_flag, abs_level_gt5_flag, abs_level_gt7_flag, and abs_level_gt9_flag, are coded using context coded bins. If the RemCcbs becomes smaller than 4 while coding the second pass, the remaining coefficients that have yet to be coded in the second pass are coded in the remainder scan pass (pass #3).

FIG. 5 illustrates the transform skip residual coding process. The star marks the position when context coded bins are exhausted, at which point all remaining bins are coded using bypass coding.

Further, for a block not coded in the BDPCM mode, a level mapping mechanism is applied to transform skip residual coding until the maximum number of context coded bins has been reached. Level mapping uses the top and left neighbouring coefficient levels to predict the current coefficient level in order to reduce signalling cost. For a given residual position, denote absCoeff as the absolute coefficient level before mapping and absCoeffMod as the coefficient level after mapping. Let X₀ denote the absolute coefficient level of the left neighbouring position and let X₁ denote the absolute coefficient level of the above neighbouring position. The level mapping is performed as follows:

```
pred = max(X0, X1);
if (absCoeff = = pred)
  absCoeffMod = 1;
else
  absCoeffMod = (absCoeff < pred) ? absCoeff + 1 : absCoeff;
```

then, the absCoeffMod value is coded as described above. After all context coded bins have been exhausted, level mapping is disabled for all remaining scan positions in the current block.

### 2.1.4 Palette Mode

In VVC, the palette mode is used for screen content coding in all of the chroma formats supported in a 4:4:4 profile (that is, 4:4:4, 4:2:0, 4:2:2 and monochrome). When palette mode is enabled, a flag is transmitted at the CU level if the CU size is smaller than or equal to 64×64, and the amount of samples in the CU is greater than 16 to indicate whether palette mode is used. Considering that applying palette mode on small CUs introduces insignificant coding gain and brings extra complexity on the small blocks, palette mode is disabled for CU that are smaller than or equal to 16 samples. A palette coded coding unit (CU) is treated as a prediction mode other than intra prediction, inter prediction, and intra block copy (IBC) mode.

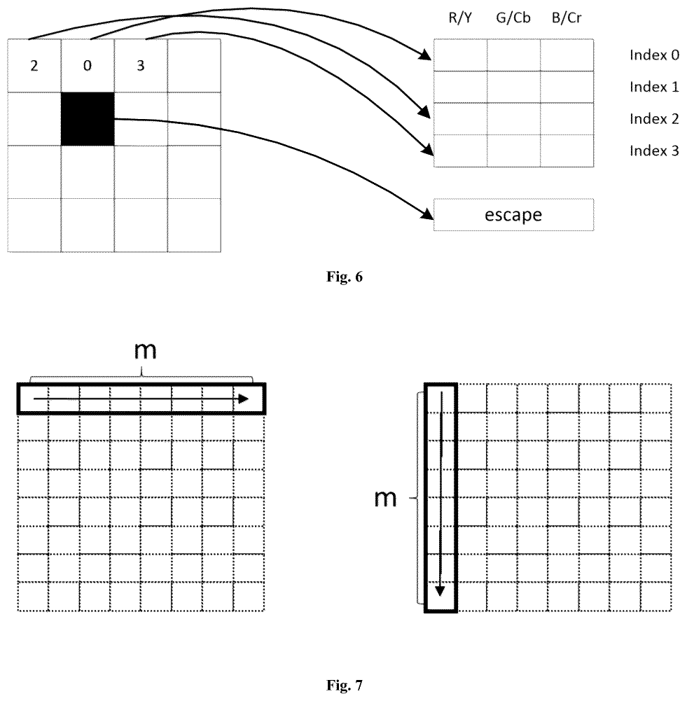

If the palette mode is utilized, the sample values in the CU are represented by a set of representative colour values. The set is referred to as the palette. For positions with sample values close to the palette colours, the palette indices are signalled. It is also possible to specify a sample that is outside the palette by signalling an escape symbol. For samples within the CU that are coded using the escape symbol, their component values are signalled directly using (possibly) quantized component values. This is illustrated in FIG. 6. The quantized escape symbol is binarized with fifth order Exp-Golomb binarization process (EG5).

For coding of the palette, a palette predictor is maintained. The palette predictor is initialized to 0 at the beginning of each slice for non-wavefront case. For WPP case, the palette predictor at the beginning of each CTU row is initialized to the predictor derived from the first CTU in the previous CTU row so that the initialization scheme between palette predictors and CABAC synchronization is unified. For each entry in the palette predictor, a reuse flag is signalled to indicate whether it is part of the current palette in the CU. The reuse flags are sent using run-length coding of zeros. After this, the number of new palette entries and the component values for the new palette entries are signalled. After encoding the palette coded CU, the palette predictor will be updated using the current palette, and entries from the previous palette predictor that are not reused in the current palette will be added at the end of the new palette predictor until the maximum size allowed is reached. An escape flag is signaled for each CU to indicate if escape symbols are present in the current CU. If escape symbols are present, the palette table is augmented by one and the last index is assigned to be the escape symbol.

In a similar way as the coefficient group (CG) used in transform coefficient coding, a CU coded with palette mode is divided into multiple line-based coefficient group, each consisting of m samples (i.e., m=16), where index runs, palette index values, and quantized colors for escape mode are encoded/parsed sequentially for each CG. Same as in HEVC, horizontal or vertical traverse scan can be applied to scan the samples, as shown in FIG. 7.

The encoding order for palette run coding in each segment is as follows: For each sample position, 1 context coded bin run_copy_flag=0 is signalled to indicate if the pixel is of the same mode as the previous sample position, i.e., if the previously scanned sample and the current sample are both of run type COPY_ABOVE or if the previously scanned sample and the current sample are both of run type INDEX and the same index value. Otherwise, run_copy_flag=1 is signaled. If the current sample and the previous sample are of different modes, one context coded bin copy_above_palette_indices flag is signaled to indicate the run type, i.e., INDEX or COPY_ABOVE, of the current sample. Here, decoder doesn't have to parse run type if the sample is in the first row (horizontal traverse scan) or in the first column (vertical traverse scan) since the INDEX mode is used by default. With the same way, decoder doesn't have to parse run type if the previously parsed run type is COPY_ABOVE. After palette run coding of samples in one coding pass, the index values (for INDEX mode) and quantized escape colors are grouped and coded in another coding pass using CABAC bypass coding. Such separation of context coded bins and bypass coded bins can improve the throughput within each line CG.

For slices with dual luma/chroma tree, palette is applied on luma (Y component) and chroma (Cb and Cr components) separately, with the luma palette entries containing only Y values and the chroma palette entries containing both Cb and Cr values. For slices of single tree, palette will be applied on Y, Cb, Cr components jointly, i.e., each entry in the palette contains Y, Cb, Cr values, unless when a CU is coded using local dual tree, in which case coding of luma and chroma is handled separately. In this case, if the corresponding luma or chroma blocks are coded using palette mode, their palette is applied in a way similar to the dual tree case (this is related to non-4:4:4 coding and will be further explained in 2.1.4.1).

For slices coded with dual tree, the maximum palette predictor size is 63, and the maximum palette table size for coding of the current CU is 31. For slices coded with dual tree, the maximum predictor and palette table sizes are halved, i.e., maximum predictor size is 31 and maximum table size is 15, for each of the luma palette and the chroma palette. For deblocking, the palette coded block on the sides of a block boundary is not deblocked.

### 2.1.4.1 Palette Mode for Non-4:4:4 Content

Palette mode in VVC is supported for all chroma formats in a similar manner as the palette mode in HEVC SCC. For non-4:4:4 content, the following customization is applied:
1. When signaling the escape values for a given sample position, if that sample position has only the luma component but not the chroma component due to chroma subsampling, then only the luma escape value is signaled. This is the same as in HEVC SCC.
2. For a local dual tree block, the palette mode is applied to the block in the same way as the palette mode applied to a single tee block with two exceptions:
   a. The process of palette predictor update is slightly modified as follows. Since the local dual tree block only contains luma (or chroma) component, the predictor update process uses the signalled value of luma (or chroma) component and fills the “missing” chroma (or luma) component by setting it to a default value of (1<<(component bit depth−1)).
   b. The maximum palette predictor size is kept at 63 (since the slice is coded using single tree) but the maximum palette table size for the luma/chroma block is kept at 15 (since the block is coded using separate palette).
3. For palette mode in monochrome format, the number of colour components in a palette coded block is set to 1 instead of 3.

### 2.1.4.2 Encoder Algorithm for Palette Mode

At the encoder side, the following steps are used to produce the palette table of the current CU.
1. First, to derive the initial entries in the palette table of the current CU, a simplified K-means clustering is applied. The palette table of the current CU is initialized as an empty table. For each sample position in the CU, the SAD between this sample and each palette table entry is calculated and the minimum SAD among all palette table entries is obtained. If the minimum SAD is smaller than a pre-defined error limit, errorLimit, then the current sample is clustered together with the palette table entry with the minimum SAD. Otherwise, a new palette table entry is created. The threshold errorLimit is QP-dependent and is retrieved from a look-up table containing 57 elements covering the entire QP range. After all samples of the current CU have been processed, the initial palette entries are sorted according to the number of samples clustered together with each palette entry, and any entry after the 31^{st} entry is discarded.
2. In the second step, the initial palette table colours are adjusted by considering two options: using the centroid of each cluster from step 1 or using one of the palette colours in the palette predictor. The option with lower rate-distortion cost is selected to be the final colours of the palette table. If a cluster has only a single sample and the corresponding palette entry is not in the palette predictor, the corresponding sample is converted to an escape symbol in the next step.
3. A palette table thus generated contains some new entries from the centroids of the clusters in step 1, and some entries from the palette predictor. So this table is reordered again such that all new entries (i.e. the centroids) are put at the beginning of the table, followed by entries from the palette predictor.

Given the palette table of the current CU, the encoder selects the palette index of each sample position in the CU. For each sample position, the encoder checks the RD cost of all index values corresponding to the palette table entries, as well as the index representing the escape symbol, and selects the index with the smallest RD cost using the following equation:

$$RD cost = distortion \times ( isChroma ? 0.8 : 1 ) + lambda \times bypass coded bits . \qquad ( 2 - 5 )$$

After deciding the index map of the current CU, each entry in the palette table is checked to see if it is used by at least one sample position in the CU. Any unused palette entry will be removed.

After the index map of the current CU is decided, trellis RD optimization is applied to find the best values of run_copy_flag and run type for each sample position by comparing the RD cost of three options: same as the previously scanned position, run type COPY_ABOVE, or run type INDEX. When calculating the SAD values, sample values are scaled down to 8 bits, unless the CU is coded in lossless mode, in which case the actual input bit depth is used to calculate the SAD. Further, in the case of lossless coding, only rate is used in the rate-distortion optimization steps mentioned above (because lossless coding incurs no distortion).

### 2.1.5 Adaptive Color Transform

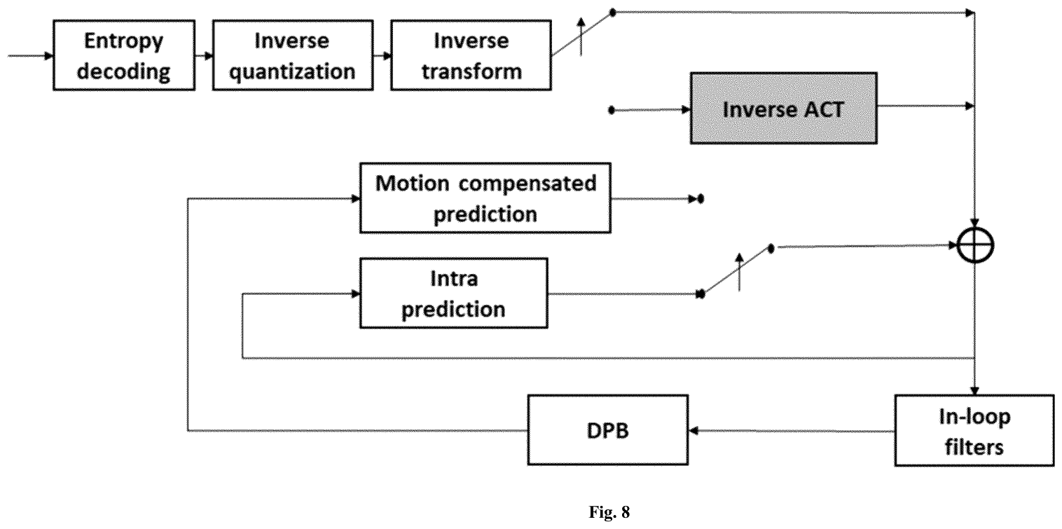

In HEVC SCC extension, adaptive color transform (ACT) was applied to reduce the redundancy between three color components in 444 chroma format. The ACT is also adopted into the VVC standard to enhance the coding efficiency of 444 chroma format coding. Same as in HEVC SCC, the ACT performs in-loop color space conversion in the prediction residual domain by adaptively converting the residuals from the input color space to YCgCo space. FIG. 8 illustrates the decoding flowchart with the ACT being applied. Two color spaces are adaptively selected by signaling one ACT flag at CU level. When the flag is equal to one, the residuals of the CU are coded in the YCgCo space; otherwise, the residuals of the CU are coded in the original color space. Additionally, same as the HEVC ACT design, for inter and IBc CUs, the ACT is only enabled when there is at least one non-zero coefficient in the CU. For intra CUs, the ACT is only enabled when chroma components select the same intra prediction mode of luma component, i.e., DM mode.

### 2.1.5.1 ACT Mode

In HEVC SCC extension, the ACT supports both lossless and lossy coding based on lossless flag (i.e., cu_transquant_bypass_flag). However, there is no flag signalled in the bitstream to indicate whether lossy or lossless coding is applied. Therefore, YCgCo-R transform is applied as ACT to support both lossy and lossless cases. The YCgCo-R reversible colour transform is shown as below.

| Forward Conversion: | Backward Conversion: | |
|---|---|---|
| GBR to YCgCo | YCgCo to GBR | |
| Co = R − B; | t = Y − (Cg >> 1) | (2-6) |
| t = B + (Co >> 1); | G = Cg + t | |
| Cg = G − t; | B = t − (Co >> 1) | |
| Y = t + (Cg >> 1); | R = Co + B | |

Since the YCgCo-R transform are not normalized. To compensate the dynamic range change of residuals signals before and after color transform, the QP adjustments of (−5, 1, 3) are applied to the transform residuals of Y, Cg and Co components, respectively. The adjusted quantization parameter only affects the quantization and inverse quantization of the residuals in the CU. For other coding processes (such as deblocking), original QP is still applied.

Additionally, because the forward and inverse color transforms need to access the residuals of all three components, the ACT mode is always disabled for separate-tree partition and ISP mode where the prediction block size of different color component is different. Transform skip (TS) and block differential pulse coded modulation (BDPCM), which are extended to code chroma residuals, are also enabled when the ACT is applied.

### 2.1.5.2 ACT Fast Encoding Algorithms

To avoid brutal R-D search in both the original and converted color spaces, the following fast encoding algorithms are applied in the VTM reference software to reduce the encoder complexity when the ACT is enabled.
The order of RD checking of enabling/disabling ACT is dependent on the original color space of input video. For RGB videos, the RD cost of ACT mode is checked first; for YCbCr videos, the RD cost of non-ACT mode is checked first. The RD cost of the second color space is checked only if there is at least one non-zero coefficient in the first color space.
The same ACT enabling/disabling decision is reused when one CU is obtained through different partition path. Specifically, the selected color space for coding the residuals of one CU will be stored when the CU is coded at the first time. Then, when the same CU is obtained by another partition path, instead of checking the RD costs of the two spaces, the stored color space decision will be directly reused.
The RD cost of a parent CU is used to decide whether to check the RD cost of the second color space for the current CU. For instance, if the RD cost of the first color space is smaller than that of the second color space for the parent CU, then for the current CU, the second color space is not checked.

To reduce the number of tested coding modes, the selected coding mode is shared between two color spaces. Specifically, for intra mode, the preselected intra mode candidates based on SATD-based intra mode selection are shared between two color spaces. For inter and IBC modes, block vector search or motion estimation is performed only once. The block vectors and motion vectors are shared by two color spaces.

### 2.1.6 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area in consisting of:
R1: current CTU,
R2: top-left CTU,
R3: above CTU,
R4: left CTU.
   SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.

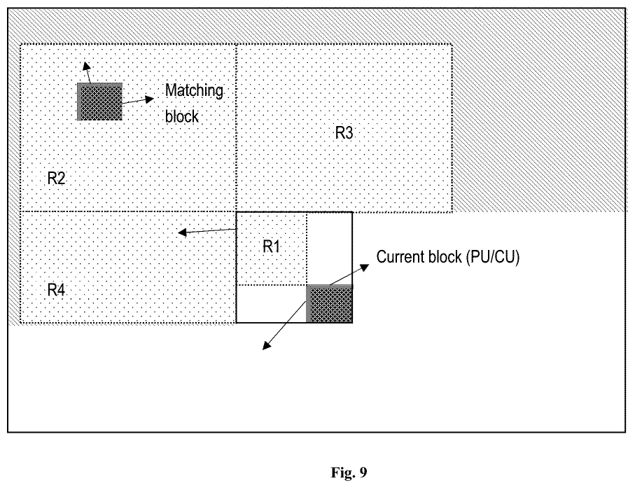

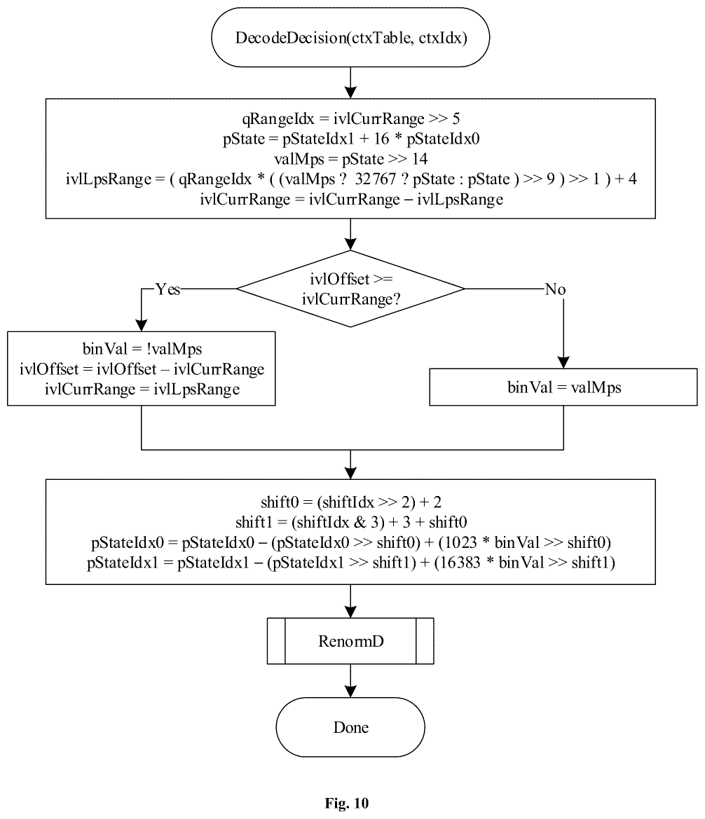

FIG. 9 illustrates intra template matching search area used. The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.2 Existing Entropy Coding Techniques

### 2.2.1 Core CABAC Engine

The CABAC engine in HEVC uses a table-based probability transition process between 64 different representative probability states. In HEVC, the range ivlCurrRange representing the state of the coding engine is quantized to a set of 4 values prior to the calculation of the new interval range. The HEVC state transition can be implemented using a table containing all 64×4 8-bit pre-computed values to approximate the values of ivlCurrRange*pLPS (pStateIdx), where pLPS is the probability of the least probable symbol (LPS) and pStateIdx is the index of the current state. Also, a decode decision can be implemented using the pre-computed LUT. First ivlLpsRange is obtained using the LUT as follows. Then, ivlLpsRange is used to update ivlCurrRange and calculate the output binVal.

ivlLpsRange=rangeTabLps[pStateIdx][qRangeIdx] (2-7)

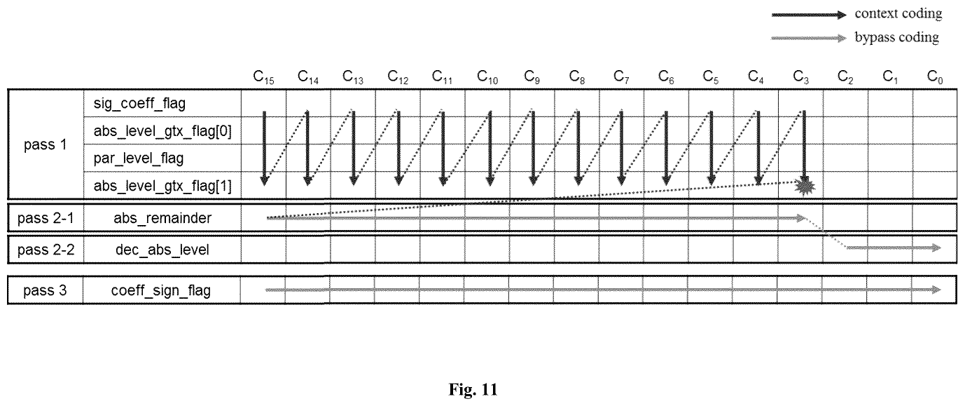

In VVC, the probability is linearly expressed by the probability index pStateIdx. Therefore, all the calculation can be done with equations without LUT operation. To improve the accuracy of probability estimation, a multi-hypothesis probability update model is applied. The pStateIdx used in the interval subdivision in the binary arithmetic coder is a combination of two probabilities pStateIdx0 and pStateIdx1. The two probabilities are associated with each context model and are updated independently with different adaptation rates. The adaptation rates of pStateIdx0 and pStateIdx1 for each context model are pre-trained based on the statistics of the associated bins. The probability estimate pStateIdx is the average of the estimates from the two hypotheses. FIG. 10 shows the flowchart for decoding a single binary decision in VVC.

As done in HEVC, VVC CABAC also has a QP dependent initialization process invoked at the beginning of each slice. Given the initial value of luma QP for the slice, the initial probability state of a context model, denoted as preCtxState, is derived as follows

$$m = slopeIdx \times 5 - 45 \qquad ( 2 - 8 )$$

$$n = ( offsetIdx << 3 ) + 7 \qquad ( 2 - 9 )$$

$$preCtxState = Clip 3 ( 1 , 1 \; 27 , ( ( m \times ( Q P - 32 ) ) >> 4 ) + n ) \qquad ( 2 - 10 )$$

where slopeIdx and offsetIdx are restricted to 3 bits, and total initialization values are represented by 6-bit precision. The probability state preCtxState represents the probability in the linear domain directly. Hence, preCtxState only needs proper shifting operations before input to arithmetic coding engine, and the logarithmic to linear domain mapping as well as the 256-byte table is saved.

$$pStateIdx 0 = preCtxState << 3 \qquad ( 2 - 11 )$$

$$pStateIdx 1 = preCtxState << 7 \qquad ( 2 - 12 )$$

### 2.2.2 Transform Coefficient Level Coding

In HEVC, transform coefficients of a coding block are coded using non-overlapped coefficient groups (CGs or subblocks), and each CG contains the coefficients of a 4×4 block of a coding block. In VVC, the selection of coefficient group sizes becomes dependent upon TB size only, i.e., remove the dependency on channel type. As a consequence, various CGs (1×16, 2×8, 8×2, 2×4, 4×2 and 16×1) become available. The CGs inside a coding block, and the transform coefficients within a CG, are coded according to pre-defined scan orders. In order to restrict the maximum number of context coded bins per pixel, the area of the TB and the colour component are used to derive the maximum number of context-coded bins for a TB. For a luma TB, the maximum number of context-coded bins is equal to TB_zosize*1.75. For a chroma TB, the maximum number of context-coded bins (CCB) is equal to TB_zosize*1.25. Here, TB_zosize indicates the number of samples within a TB after coefficient zero-out. Note that the coded_sub_block_flag in transform skip residual mode is not considered for CCB count. Unlike HEVC where residual coding is designed for the statistics and signal characteristics of transform coefficient levels, two separate residual coding structures are employed for transform coefficients and transform skip coefficients, respectively.

### 2.2.2.1 Residual Coding for Transform Coefficients

In transform coefficient coding, a variable, remBinsPass1, is first set to the maximum number of context-coded bins and is decreased by one when a context-coded bin is signalled. While the remBinsPass1 is larger than or equal to four, the first coding pass, which includes the sig_coeff_flag, abs_level_gt1_flag, par_level_flag, and abs_level_gt3_flag, is coded by using context-coded bins. If the number of context coded bin is not greater than Mccb in the first pass coding, the rest part of level information, which is indicated to be further coded in the first pass, is coded with syntax element of abs_remainder by using Golomb-rice code and bypass-coded bins. When the remBinsPass1 becomes smaller than 4 while coding the first pass, the rest part of coefficients, which are indicated to be further coded in the first pass, are coded with a syntax element of abs_remainder, and coefficients which are not coded in the first pass is directly coded in the second pass with the syntax element of dec_abs_level by using Golomb-Rice code and bypass-coded bins as depicted in FIG. 8. The remBinsPass1 is reset for every TB. The transition of using context-coded bins for the sig_coeff_flag, abs_level_gt1_flag, par_level_flag, and abs_level_gt3_flag to using bypass-coded bins for the rest coefficients only happens at most once per TB. For a coefficient subblock, if the remBinsPass1 is smaller than 4, the entire coefficient subblock is coded by using bypass-coded bins. After all the above mentioned level coding, the signs (sign_flag) for all scan positions with sig_coeff_flag equal to 1 is finally bypass coded.

The unified (same) rice parameter (ricePar) derivation is used for Pass 2 and Pass 3. The only difference is that baseLevel is set to 4 and 0 for Pass 2 and Pass 3, respectively. Rice parameter is determined not only based on sum of absolute levels of neighboring five transform coefficients in local template, but the corresponding base level is also taken into consideration as follow:

$$RicePara = RiceParTable [ max ( min ( 31 , sum Abs - 5 * baseLevel ) , 0 ) ] \qquad ( 2 - 13 )$$

FIG. 11 shows residual coding structure for transform blocks. After the termination of the 1st subblock coding pass, the absolute value of each of the remaining yet-to-be-coded coefficients is coded by the syntax element dec_abs_level, which corresponds to a modified absolute level value with the zero-level value being conditionally mapped to a nonzero value. At the encoder side, the value of syntax element dec_abs_level is derived from the absolute level (absLevel), dependent quantizer state (QState) and the value of rice parameter (RicePara) as follows:

```
ZeroPos = ( QState < 2? 1 : 2 ) << RicePara
if (absLevel == 0)
  dec_abs_level = ZeroPos
else
  dec_abs_level = (absLevel <= ZeroPos) ? (absLevel − 1) : absLevel.
```

### 2.2.2.2 Residual Coding for Transform Skip

Similar to HEVC, VVC supports transform skip mode. Transform skip mode is allowed for luma and chroma blocks. In transform skip mode, the statistical characteristics of the signal are different from those of transform coefficients, and applying transform to such residual in order to achieve energy compaction around low-frequency components is generally less effective. Residuals with such characteristics are often found in screen content as opposed to natural camera captured content.

### 2.2.3 Context Modeling for Coefficient Coding

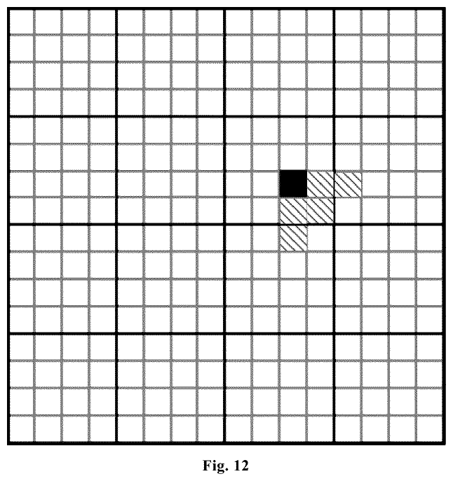

The selection of probability models for the syntax elements related to absolute values of transform coefficient levels depends on the values of the absolute levels or partially reconstructed absolute levels in a local neighbourhood. The template used is illustrated in FIG. 12.

The selected probability models depend on the sum of the absolute levels (or partially reconstructed absolute levels) in a local neighbourhood and the number of absolute levels greater than 0 (given by the number of sig_coeff_flags equal to 1) in the local neighbourhood. The context modelling and binarization depends on the following measures for the local neighbourhood:
numSig: the number of non-zero levels in the local neighbourhood;
sumAbs1: the sum of partially reconstructed absolute levels (absLevel1) after the first pass in the local neighbourhood;
sumAbs: the sum of reconstructed absolute levels in the local neighbourhood;
diagonal position (d): the sum of the horizontal and vertical coordinates of a current scan position inside the transform block.

Based on the values of numSig, sumAbs1, and d, the probability models for coding sig_flag, par_flag, gt1_flag, and gt2_flag are selected. The Rice parameter for binarizing abs_remainder is selected based on the values of sumAbs and numSig.

In VVC reduced 32-point MTS (RMTS32) based on skipping high frequency coefficients is used to reduce computational complexity of 32-point DST-7/DCT-8. And, it accompanies coefficient coding changes considering all types of zero-out (i.e., RMTS32 and the existing zero out for high frequency components in DCT2). Specifically, binarization of last non-zero coefficient position coding is coded based on reduced TU size, and the context model selection for the last non-zero coefficient position coding is determined by the original TU size. In addition, 60 context models are used to encode the sig_coeff_flag of transform coefficients. The selection of context model index is based on a sum of a maximum of five previously partially reconstructed absolute level called locSumAbsPass1 as follows:
If cIdx is equal to 0, ctxInc is derived as follows:

$$ctxInc = 12 * Max ( 0 , QState - 1 ) + Min ( ( loc Sum Abs Pass 1 + 1 ) >> 1 , 3 ) + ( d < 2 ? 8 : ( d < 5 ? 4 : 0 ) ) \qquad ( 2 - 14 )$$

Otherwise (cIdx is greater than 0), ctxInc is derived as follows:

$$ctxInc = 36 + 8 * Max ( 0 , QState - 1 ) + Min ( ( loc Sum Abs Pass 1 + 1 ) >> 1 , 3 ) + ( d < 2 ? 4 : 0 ) . \qquad ( 2 - 15 )$$

### 2.2.4 Extended Precision

The intermediate precision used in the arithmetic coding engine is increased, including three elements. First, the precisions for two probability states are both increased to 15 bits, in comparison to 10 bits and 14 bits in VVC. Second, the LPS range update process is modified as below,

$$if q >= 16384$$

$$q = {2}^{15} - 1 - q$$

$${R}_{LPS} = ( ( range * ( q >> 6 ) ) >> 9 ) + 1 ,$$

where range is a 9-bit variable representing the width of the current interval, q is a 15-bit variable representing the probability state of the current context model, and RLPS is the updated range for LPS. This operation can also be realized by looking up a 512×256-entry in 9-bit look-up table. Third, at the encoder side, the 256-entry look-up table used for bits estimation in VTM is extended to 512 entries.

### 2.2.5 Slice-Type-Based Window Size

Since statistics are different with different slice types, it is beneficial to have a context's probability state updated at a rate that is optimal under the given slice type. Therefore, for each context model, three window sizes are pre-defined for I-, B-, and P-slices, respectively, like the initialization parameters.

The context initialization parameters and window sizes are retrained.

### 2.2.6 Temporal CABAC

Utilizing previous coded slices for CABAC initialization was used in JEM, proposed in JVET-K0379 and studied in VVC CE5.

Specifically, if the current slice type is a B or P, the probability state of each context model is first obtained after coding CTUs up to a specified location and stored. Then, the stored probability state will be used as the initial probability state for the corresponding context model in the next B- or P-slice coded with the same quantization parameter (QP).

2.3 Adaptive Reordering of Merge Candidates with Template Matching (ARMC)

The merge candidates are adaptively reordered with template matching (TM). The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

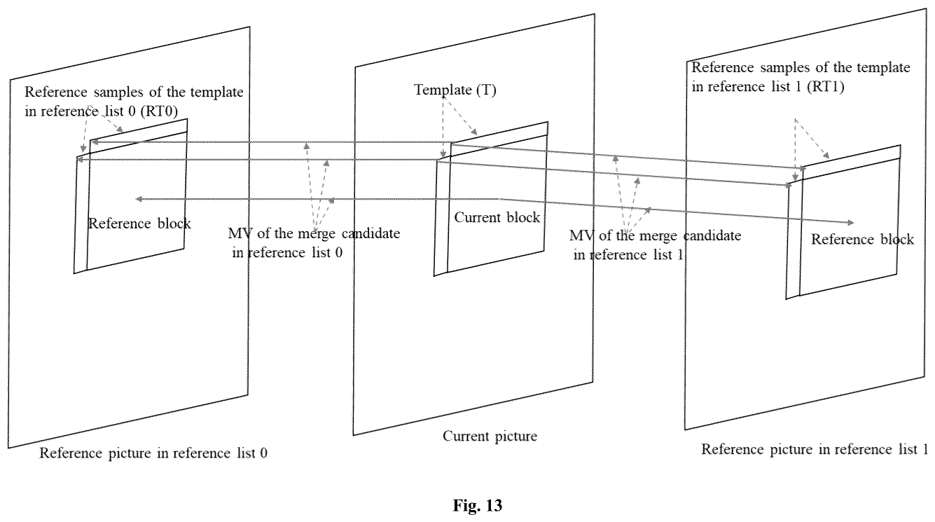

When a merge candidate utilizes bi-directional prediction, the reference samples of the template of the merge candidate are also generated by bi-prediction as shown in FIG. 13.

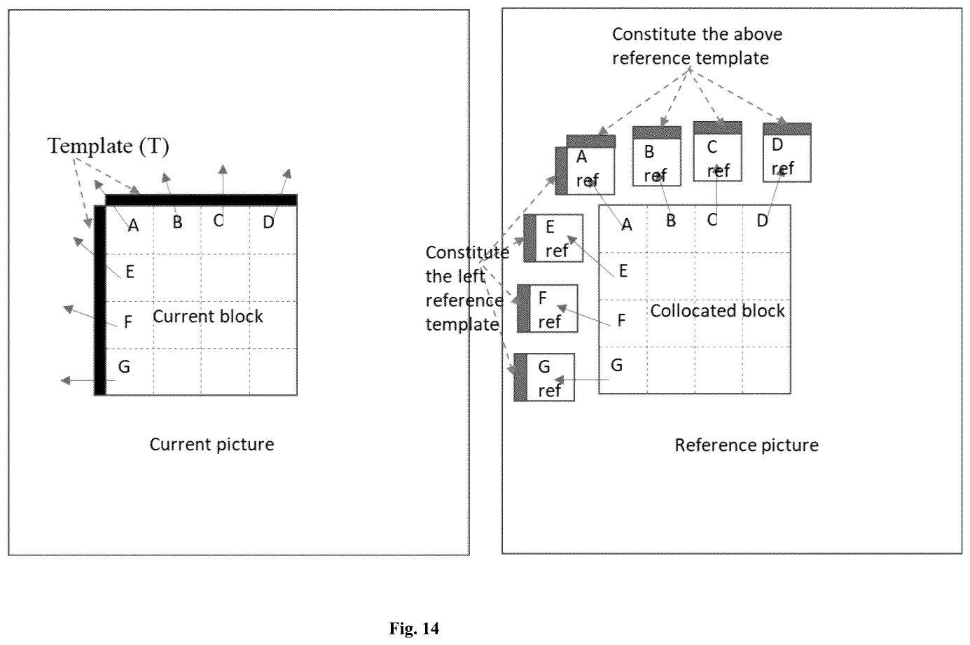

For subblock-based merge candidates with subblock size equal to Wsub×Hsub, the above template comprises several sub-templates with the size of Wsub×1, and the left template comprises several sub-templates with the size of 1×Hsub. As shown in FIG. 14, the motion information of the subblocks in the first row and the first column of current block is used to derive the reference samples of each sub-template.

### 3 Problems

There are several issues in the existing video coding techniques, which would be further improved for higher coding gain.
1. The CABAC initialization probabilities of an inter slice can be inherited from stored probabilities of a previous coded slice, for example, temporal CABAC. However, how to derive the context initialization probabilities from temporal information needs to be designed, especially when a temporal picture contains more than one slice.
2. In ECM-4.0, a sign prediction is used to estimate the sign (+ or −) of regular AMVP motion vector differences (MVDs), but not for IBC AMVP. The sign of IBC MVD can be predictive coded.
3. In VVC and ECM, when the IBC predictor pointed by a motion vector candidate is not in a valid region, then this motion vector candidate is treated as invalid. However, in such case, new motion vector candidates may be inserted into the IBC motion list, based on the invalid IBC motion candidate.
4. Currently in ECM-4.0, intra template matching is only applied for luma component. For chroma, if it is signaled as DM mode, then set the chroma mode to Planar mode (without reusing the concept of intra template matching). However, for extensions of intra template matching (e.g., if sample reordering based intra template matching is enabled), how to deal with the chroma block coding may be further defined.
5. For motion list building considering sample ordering, more technical details may be defined.
   a. Whether and how to consider flip type of neighbor block and current block for IBC AMVP list building.
   b. Whether and how to consider flip type of neighbor block and current block for motion candidates reordering/sorting (e.g., ARMC).
   c. A new motion candidate may be generated based on sample reordering.

### 4 Detailed Solutions

The detailed inventions below should be considered as examples to explain general concepts. These inventions should not be interpreted in a narrow way. Furthermore, these inventions can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

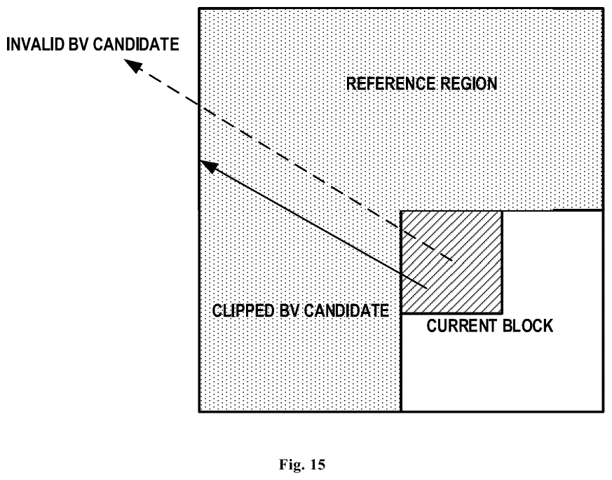

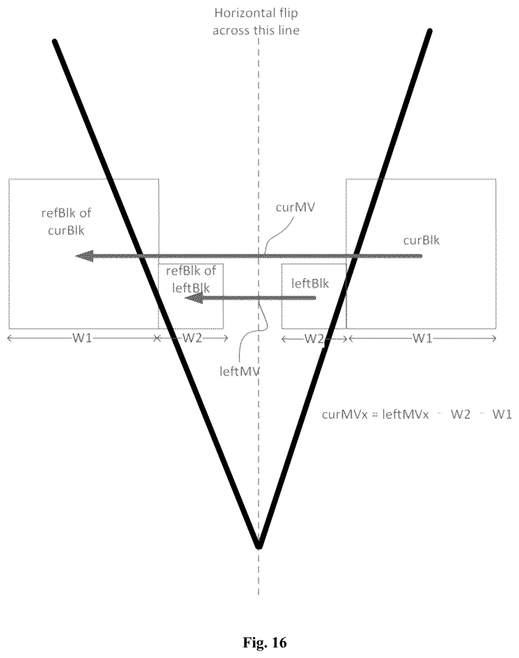

It is noted that the terminologies mentioned below are not limited to the specific ones defined in existing standards. Any variance of the coding tool is also applicable.
4.1 About the CABAC initialization probabilities (e.g., the first problem and related issues), the following methods are proposed:
   a. The context initialization probabilities of a first slice may be required to be NOT dependent on context initialization probabilities obtained from a second slice in the same picture (e.g., in case that more than one slice is included in each picture of a video sequence).
      a. For example, the second slice is coded prior to the first slice.
   b. The context initialization probabilities of a first slice may be required to be NOT dependent on context initialization probabilities obtained from a second slice in a different picture.
   c. The context initialization probabilities of a first slice in a first picture may be dependent on context initialization probabilities obtained from a second slice in a second picture.
      a. For example, the first picture is different from the second picture.
      b. For example, the second picture is coded prior to the first picture.
      c. For example, the second picture may be a reference picture of the first slice/picture.
      d. For example, the second picture may be NOT necessarily a reference picture of the first slice/picture.
   d. The initialization probability dependency of a first slice and a second slice may be based on slice type but NOT quantization parameters (QP).
      a. For example, the context initialization probabilities of a first slice may be dependent on the context initialization probabilities of a second slice, in case that the first slice and the second slice are coded with same slice type X (such as X=B or P slice).
      b. For example, the context initialization probabilities of a first slice may be dependent on the context initialization probabilities of a second slice, no matter the QP values used for the first slice and the second slice.
   e. The context initialization probabilities of a first slice may be dependent on context initialization probabilities obtained from a second slice based on quantization parameters (QP).
      a. For example, how the first slice derive context initialization probabilities from a second slice may be based on whether the first slice and the second slice are of same/similar QP values (e.g., whether the QP difference is less than a threshold).
      b. For example, how the first slice derive context initialization probabilities from a second slice may be based on whether the first slice and the second slice are from same QP range (e.g., the QP ranges may be defined by pre-defined rules).
      c. For example, how the first slice derive context initialization probabilities from a second slice may be based on whether the first slice and the second slice are from same QP category (e.g., the QP categories may be defined by pre-defined rules).
   f. The temporal layer of a second slice may be required to be NO greater than the temporal layer of a first slice, in case that the first slice derives context initialization probabilities from the second slice.
      a. For example, in case that the first slice derives context initialization probabilities from a second slice, the temporal layer of the second slice may be less than the temporal layer of the first slice.
      b. For example, in case that the first slice derives context initialization probabilities from a second slice, the temporal layer of the second slice may equal to the temporal layer of the first slice.
      c. For example, in case that the first slice derives context initialization probabilities from a second slice, the temporal layer of the second slice should not be greater than the temporal layer of the first slice.
   g. In one example, the context initialization probabilities of a first slice may be dependent on context initialization probabilities obtained from a second slice, and indication of the second slice may be signaled in the first slice.
   h. In one example, the context initialization probabilities of a first slice may be dependent on context initialization probabilities obtained from a second slice, and the second slice must be a reference slice of the first slice.
4.2 About the sign prediction of block vector differences (e.g., the second problem and related issues), the following methods are proposed:
   a. The sign of horizontal component and/or vertical component of a block vector difference (e.g., BVD, MVD) of an IBC coded video unit may be predictive coded.
   b. The sign of a block vector difference (e.g., BVD, MVD) component of an IBC coded video unit may be represented by an index from a look-up-table.
      a. For example, the sign candidates in the look-up-table may be pre-defined and used for both encoder and decoder.
      b. For example, the sign candidates in the look-up-table may be generated on the fly.
      c. For example, at least two kinds of sign look-up tables may be allowed for coding IBC block vector differences.
         i. For example, the sign look-up table is per block basis.
         ii. For example, the order of sign candidates in a first sign look-up table and that in the second sign look-up table may be different.
      d. For example, the sign candidates in the look-up-table may be generated based on cost/error/difference obtained from a template matching method.
         i. For example, the sign candidates in the look-up-table may be reordered based on template matching methods.
         ii. For example, the template matching may refer to match a first predefined group of reconstructed samples neighboring to a first block (e.g., current block) and a second predefined group of reconstructed samples neighboring to a second block (e.g., the reference block of the current block).
      e. For example, the index of the sign of the block vector difference (e.g., BVD, MVD) component of an IBC coded video unit may be context coded.
4.3 About the out-of-valid-region block vectors (e.g., the third problem and related issues), the following methods are proposed:
   a. If a block vector candidate of an IBC coded block is outside of the reference region, the block vector may be changed to another value instead of being discarded from an IBC candidate list.
      a. For example, an operation may be applied to the block vector and change it to a valid block vector within the reference region.
         i. For example, the operation may be based on a clipping process.
         ii. For example, the operation may be based on a scaling process.
      b. For example, a clipping operation may be applied to the block vector to clip it within the reference region.
         i. For example, it may be clipped to the nearest boundary of the reference region, for example, as shown in FIG. 15.
      c. For example, a new block vector may be used instead to replace the invalid block vector.
4.4 About the chroma block coding of sample ordering (e.g., the 4th problem and related issues), the following methods are proposed:
   a. For example, the luma block and chroma block of a video unit may share a same block vector, when intra template matching is used.
      i. For example, if an intra template matching is applied to a luma block, the associated chroma block may derive the chroma prediction based on the block vector calculated from the luma block.
   b. For example, the luma block and chroma block of a video unit may share a same sample reordering method (e.g., no flip, horizontal flip, vertical flip, etc.).
      i. For example, if a sample reordering method is applied to a luma block, the associated chroma block may perform same sample reordering method as the luma block.
      ii. For example, the luma block may be coded as intra template matching based sample reordering.
   b. For example, sample reordering (e.g., horizontal flip, vertical flip, etc.) may be only applied to luma component given that the luma component is coded based on a certain coding method.
      i. For example, the certain coding method may be based on intra template matching.
   c. For example, in case that the luma block is coded with a sample reordering method, the chroma block may be coded with a different prediction method from that of luma block.
      i. For example, the chroma block may be coded with a kind of chroma intra mode (e.g., DM mode, Planar mode, DC mode, CCLM mode, etc.), while the luma block is coded with a sample reordering method (e.g., no flip, horizontal flip, vertical flip, etc.).
      ii. For example, the chroma block may be coded with a kind of chroma intra mode (e.g., DM mode, Planar mode, DC mode, CCLM mode, etc.), while the luma block is coded with a sample reordering based intra template matching.
   d. For example, the claimed rule may be dependent on whether dual tree (and/or local dual tree) is applied.
      i. Alternatively, the claimed rule may be applied, regardless of whether dual tree (and/or local dual tree) is applied.
4.5 About the motion list building considering the sample ordering (e.g., the 5th problem and related issues), the following methods are proposed:
   Assume a first block is a neighbor block coded prior to the current block, a target block is the current block being coded:
      d. A motion list may be generated considering the reordering methods (e.g., no flip, horizontal flip, vertical flip, etc.).
         i. In one example, the reordering method of a first block (e.g., a neighbor block already coded) may be checked for the motion list generation.
         ii. In one example, the reordering method of a target block (e.g., the current block being coded) may be checked for the motion list generation.
         iii. In one example, as long as the first block (e.g., a neighbor block) is coded with a sample reordering method, the motion derived from the first block may be adjusted (e.g., by adding a motion shift or a delta MV) for the motion list construction of the target block.
         iv. In one example, as long as the target block (e.g., the current block) is coded with a sample reordering method, the motion derived from the first block may be adjusted (e.g., by adding a motion shift or a delta MV) for the motion list construction of the target block.
         v. In one example, as long as the reordering method of a first block (e.g., a neighbor block) and the reordering method of the target block (e.g., the current block) are same (e.g., both are coded with no sample reordering, or horizontal flip, or vertical flip, etc.),
         1. For example, the motion the first block (and/or its variant) may be inserted to the motion list of the target block.
         2. For example, the motion derived from the first block may be adjusted (e.g., by adding a motion shift or a delta MV) for the motion list construction of the target block.
      e. The motion candidate indexes sorting (e.g., ARMC) may be dependent on the sample reordering method used to neighbor blocks and/or the sample reordering method used to the target block (e.g., current block).
         i. For example, the motion candidates may be grouped depending on the sample reordering methods (e.g., no flip, horizontal flip, vertical flip, etc.).
         1. For example, the motion candidates derived from sample reordering coded neighboring blocks may be put at the front of the motion list.
         a. Alternatively, those motion candidates may be put at the end of the motion list.
         2. For example, the motion candidates derived from non-sample-reordering coded neighboring blocks may be put after the motion candidates derived from sample reordering coded neighbor blocks.
         a. Alternatively, those motion candidates may be put before the motion candidates derived from sample reordering coded neighbor blocks.
         ii. For example, the motion candidates derived from neighboring blocks coded with a first coding method may be treated as a first group for candidate index sorting (e.g., ARMC), while the motion candidates derived from neighboring blocks coded with a second coding method may be treated as a second group for candidate index sorting (e.g., ARMC).
         1. For example, the first coding method may be referred to all kinds of sample reordering methods (e.g., any types of horizontal flip, vertical flip, etc.).
         a. Alternatively, the first coding method may be referred to a certain type of sample reordering method (e.g., horizontal flip, or, vertical flip, etc.).
         b. Alternatively, the first coding method may be referred to the sample reordering method same as the current/target block.
         2. For example, the second coding method may be referred to non-sample-reordering method.
         a. Alternatively, the second coding method may be referred to a certain type of sample reordering method (e.g., vertical flip, or, horizontal flip, etc.).
         3. For example, the motion candidates derived from neighboring blocks coded with a same sample reordering method may be treated as one group for candidate index sorting (e.g., ARMC).
         4. For example, only the motion candidates derived from neighboring blocks coded with sample reordering methods may be applicable for candidate index sorting (e.g., ARMC).
         5. For example, only the motion candidates derived from neighboring blocks coded with a certain type (e.g., horizontal flip, or, vertical flip, etc.) of sample reordering method may be applicable for candidate index sorting (e.g., ARMC).
         6. For example, only the motion candidates derived from neighboring blocks coded with non-sample-reordering method may be applicable for candidate index sorting (e.g., ARMC).
         7. For example, only if the motion candidates derived from neighboring blocks coded with the same sample reordering method as the target block, those motion candidates may be sorted (e.g., ARMC).
      f. At least one new motion candidate may be added to the motion list.
         i. For example, the new motion candidate may be generated based on motion adjustment (e.g., by adding a motion shift or a delta MV), considering the reordering method.
         ii. For example, the new motion candidate may be required to have the same reordering method (e.g., no reorder, horizontal flip, vertical flip, and etc.) as the target block.
         1. Alternatively, the new motion candidate may not necessarily have the same reordering method (e.g., no reorder, horizontal flip, vertical flip, and etc.) as the target block.
         iii. For example, the new motion candidate may be generated based on the motion of an adjacent neighbor block.
         iv. For example, the new motion candidate may be generated based on the motion of a non-adjacent neighbor block.
         v. For example, the new motion candidate may be generated based on a motion from a certain buffer (look-up-table, HMVP table, etc.).
         vi. For example, the claimed rule may be used when a motion list is not fulfilled (the length of the motion list is less than a pre-defined value).
      g. In one example, the claimed motion list may be a block/motion vector list of IBC coded block.
         i. For example, it may be IBC AMVP coded.
         ii. For example, it may be IBC merge coded.
         iii. Alternatively, the motion list may be used for a coding mode different from IBC.
      h. For example, the claimed rule may be used in case that the FIRST block is coded with a sample reordering method.
         i. Alternatively, the claimed rule may be used in case that the FIRST block is NOT coded with sample reordering.
         ii. Alternatively, the claimed rule may be used regardless of the sample reordering method of the FIRST block.
      i. For example, the claimed rule may be used in case that the TARGET block is coded with a sample reordering method.
         i. Alternatively, the claimed rule may be used in case that the TARGET block is NOT coded with sample reordering.
         ii. Alternatively, the claimed rule may be used regardless of the sample reordering method of the TARGET block.
      j. For example, the claimed rule may be used in case that the target block is coded with IBC AMVP (and/or its variant).
         i. Alternatively, the claimed rule may be used in case that the target block is coded an AMVP mode different from IBC AMVP.
      k. For example, the claimed rule may be used in case that the target block is coded IBC merge (and/or its variant).
         i. Alternatively, the claimed rule may be used in case that the target block is coded with a merge mode different from IBC merge.

### General Claims

4.6 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4.7 Whether to and/or how to apply the disclosed methods above may be signalled at PB/TB/CB/PU/TU/CU/VPDU/CTU/CTU row/slice/tile/sub-picture/other kinds of region contain more than one sample or pixel.
4.8 Whether to and/or how to apply the disclosed methods above may be dependent on coded information, such as block size, colour format, single/dual tree partitioning, colour component, slice/picture type.

### 5 Previous Solutions

### 5.1 on Sample Reordering-Motion List Generation, Implicit Derivation, and how to Reorder_v1

The detailed inventions below should be considered as examples to explain general concepts. These inventions should not be interpreted in a narrow way. Furthermore, these inventions can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

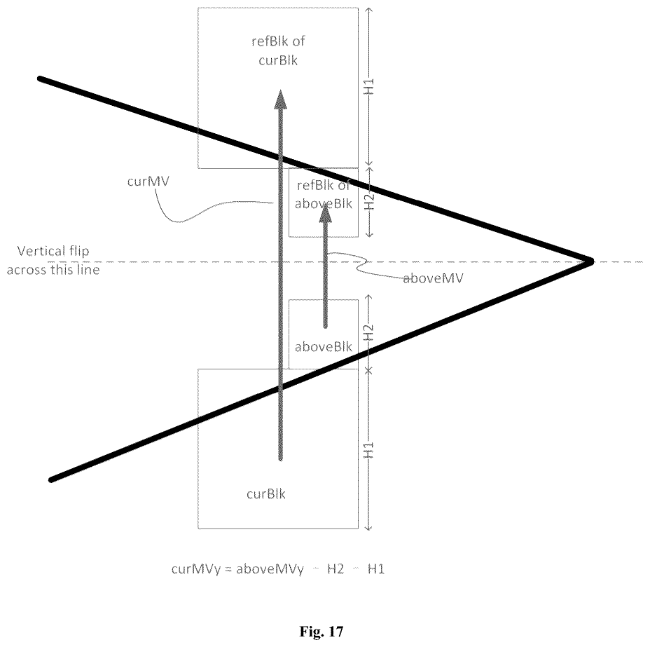

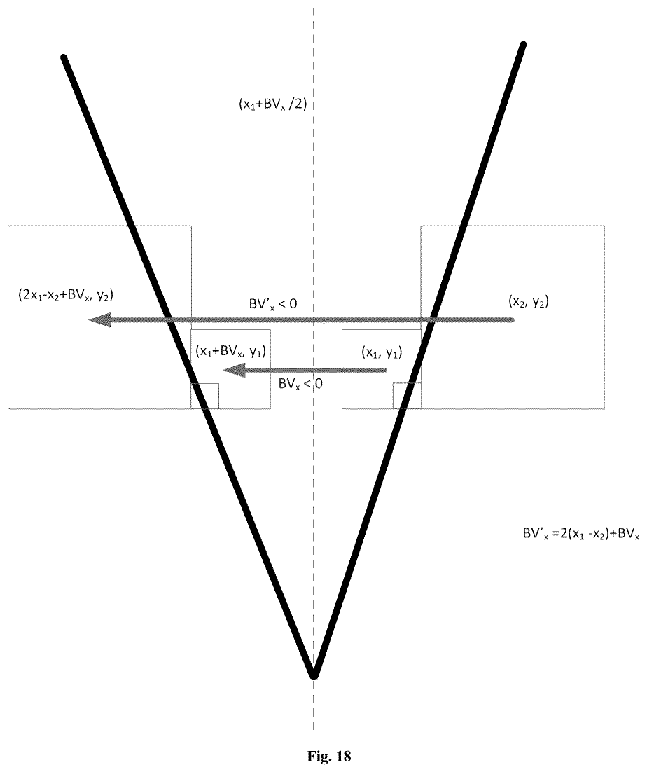

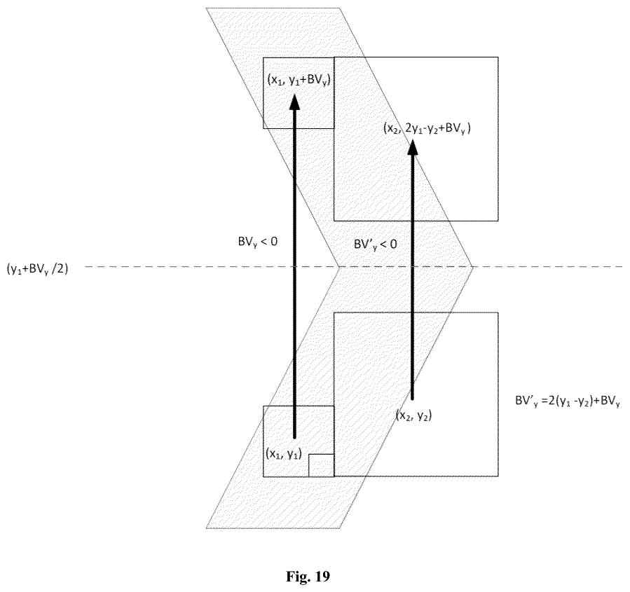

It is noted that the terminologies mentioned below are not limited to the specific ones defined in existing standards. Any variance of the coding tool is also applicable.
5.1.1 About the motion candidate list generation for sample reordering (e.g., the 1st and related issues), the following methods are proposed:
a. For example, IBC merge motion candidate list may be used for both regular IBC merge mode and sample reordering based IBC merge mode.
b. For example, IBC amvp motion predictor candidate list may be used for both regular IBC amvp mode and sample reordering based IBC amvp mode.
c. For example, a new motion (predictor) candidate list may be generated for a target video unit coded with sample reordering.
   a. For example, the new candidate list may only consider motion candidates with same reordering method as the reordering method of the target video unit.
   b. For example, the new candidate list may only consider motion candidates coded with sample reordering (but no matter the type of sample reordering method).
   c. Alternatively, the new candidate list may be generated without considering the sample reordering method of each motion candidate.
   d. For example, non-adjacent motion candidates may be inserted to the new candidate list.
      i. For example, non-adjacent candidates with sample reordering (but no matter the type of sample reordering method) may be inserted.
      ii. For example, non-adjacent candidates with same reordering method as the reordering method of the target video unit may be inserted.
      iii. For example, non-adjacent candidates may be inserted no matter the sample reordering method is used to the candidate or not.
   e. For example, new motion candidates may be generated according to a certain rule and inserted to the new candidate list.
      i. For example, the rule may be based on averaging process.
      ii. For example, the rule may be based on clipping process.
      iii. For example, the rule may be based on scaling process.
d. For example, the motion (predictor) candidate list generation for a target video unit may be dependent on the reordering method.
   a. For example, the reordering method associated with each motion candidate (from spatial or temporal or history tables) may be inserted to the list, no matter the target video unit is to be coded with sample reordering or not.
   b. For example, if the target video unit is to be coded with sample reordering, only those motion candidates (from spatial or temporal or history tables) who coded with same reordering method as the reordering method of the target video unit are inserted to the list.
   c. For example, if the target video unit is to be coded with sample reordering, only those motion candidates (from spatial or temporal or history tables) who coded with sample reordering (but no matter the type of sample reordering method) are inserted to the list.
   d. For example, if the target video unit is to be coded WITHOUT sample reordering, those motion candidates (from spatial or temporal or history tables) who coded with same reordering method may not be inserted to the list.
   e. Alternatively, the motion list generation for a video unit may not be dependent on the reordering method associated with each motion candidate.
e. For example, the Adaptive Reordering of Merge Candidates (ARMC) of a video unit may be dependent on the reordering method.
   a. For example, if the target video unit is to be coded with sample reordering, the motion candidates who coded with same reordering method as the reordering method of the target video unit may be put prior to those motion candidates who coded with different reordering method.
   b. For example, if the target video unit is to be coded with sample reordering, the motion candidates who coded with sample reordering (but no matter the type of sample reordering method) may be put prior to those motion candidates who coded with different reordering method.
   c. For example, if the target video unit is to be coded WITHOUT sample reordering, the motion candidates who coded without reordering method may be put prior to those motion candidates who coded with reordering method.
   d. Alternatively, the ARMC may be applied to the video unit, no matter the reordering method associated with each motion candidate.
f. For example, an IBC merge candidate list may be constructed, allowing a candidate to be coded with or without sample reordering.
   a. For example, a candidate from a spatial/temporal block is determined to be with or without sample reordering depending on whether the spatial/temporal block is coded with or without sample reordering.
   b. For example, a candidate from a history table entry is determined to be with or without sample reordering depending on whether the block corresponding to the history table entry is coded with or without sample reordering.
   c. For example, the current block is determined to be coded with or without sample reordering depending on whether the selected IBC merge candidate is coded with or without sample reordering.
5.1.2 About the implicit determination of sample reordering (e.g., the 2nd and related issues), the following methods are proposed:
a. Whether or not reordering the reconstruction/original/prediction samples of a video unit may be implicitly derived from coded information at both encoder and decoder.
   a. The implicit derivation may be based on costs/errors/differences calculated from coded information.
      i. For example, costs/errors/differences may be calculated based on template matching.
      ii. For example, the template matching may be conducted by comparing samples in a first template and a second template.
         1. For example, the first template is constructed by a group of pre-defined samples neighboring to current video unit, while the second template is constructed by a group of corresponding samples neighboring to a reference video unit.
         2. For example, the cost/error may refer to the accumulated sum of differences between samples in the first template and corresponding samples in the second template.
         a. For example, the difference may be based on luma sample value.
         3. For example, the sample may refer to reconstruction sample, or a variant based on reconstruction sample.
         4. For example, the sample may refer to prediction sample, or a variant based on prediction sample.
   b. For example, a first cost may be calculated without reordering (denoted by Cost0), a second cost may be calculated with reordering (denoted by Cost1). Eventually, the minimum cost value among {Cost0, Cost1} is identified and the corresponding coding method (without reorder, or, reorder) is determined as the final coding method of the video unit.
   c. Alternatively, whether reordering the reconstruction/original/prediction samples of a video unit may be signalled in the bitstream.
      i. For example, it may be signalled by a syntax element (e.g., flag).
b. Which reordering method is used to reorder the reconstruction/original/prediction samples may be implicitly derived from coded information at both encoder and decoder.
   a. For example, whether horizontal flipping or vertical flipping.
   b. The implicit derivation may be based on costs/errors/differences calculated from coded information.
      i. For example, costs/errors/differences may be calculated based on template matching.
      ii. For example, the template matching may be conducted by comparing samples in a first template and a second template.
         1. For example, the first template is constructed by a group of pre-defined samples neighboring to current video unit, while the second template is constructed by a group of corresponding samples neighboring to a reference video unit.
         2. For example, the cost/error may refer to the accumulated sum of differences between samples in the first template and corresponding samples in the second template.
         a. For example, the difference may be based on luma sample value.
         3. For example, the sample may refer to reconstruction sample, or a variant based on reconstruction sample.
         4. For example, the sample may refer to prediction sample, or a variant based on prediction sample.
      iii. For example, a first cost may be calculated without reordering method A (denoted by Cost0), a second cost may be calculated with reordering method B (denoted by Cost1). Eventually, the minimum cost value among {Cost0, Cost1} is identified and the corresponding coding method (reorder method A, reorder method B) is determined as the final coding method of the video unit.
   c. Alternatively, which reordering method is used to reorder the reconstruction/original/prediction samples of a video unit may be signalled in the bitstream.
      i. For example, it may be signalled by a syntax element (e.g., flag, or an index, or a parameter, or a variable).
c. Whether or not AND which reordering method is used to reorder the reconstruction/original/prediction samples of a video unit may be implicitly derived from coded information at both encoder and decoder.
   a. For example, a first cost may be calculated without reordering (denoted by Cost0), a second cost may be calculated with reordering method A (denoted by Cost1); a third cost may be calculated with reordering method B (denoted by Cost2). Eventually, the minimum cost value among {Cost0, Cost1, Cost2} is identified and the corresponding coding method (without reorder, reorder method A, reorder method B) is determined as the final coding method of the video unit.
5.1.3 About how to reorder samples (e.g., the 3rd and related issues), the following methods are proposed:
a. A possible sample reordering method may refer to one or more processes as followings:
   a. The reordering process may be applied based on video units.
      i. For example, the reordering process may be based on a block/CU/PU/TU.
      ii. For example, the reordering process may not be based on a tile/slice/picture.
   b. Samples of a video unit may be transformed according to a M-parameter model (such as M=2 or 4 or 6 or 8).
   c. Samples of a video unit may be reordered.
   d. Samples of a video unit may be rotated.
   e. Samples of a video unit may be transformed according to an affine model.
   f. Samples of a video unit may be transformed according to a linear model.
   g. Samples of a video unit may be transformed according to a projection model.
   h. Samples of a video unit may be flipped along the horizontal direction.
   i. Samples of a video unit may be flipped along the vertical direction.
5.1.4 About motion vector adjustment for sample reordering (e.g., the 4th and related issues), the following methods are proposed:
a. Suppose a first motion vector is obtained for a sample reordering coded video unit (e.g., current block) based on a neighbor block's coding information, a second motion vector may be generated to refine/adjust the first motion vector.
   a. For example, a motion vector candidate for IBC merge mode may be obtained based on the second motion vector.
   b. For example, a motion vector predictor for IBC AMVP mode may be obtained based on the second motion vector.
   c. For example, how to generate the second motion vector may be based on the prediction method (such as whether the video unit is coded by MERGE mode, or AMVP mode) of the current block.
   d. For example, the second motion vector may be generated based on the block dimension (such as block width, and/or height) of the current block.
   e. For example, the second motion vector may be generated based on a fixed/predefined number (such as 4 or 8 which may be the granularity of the spatial motion vector storage unit).
   f. For example, the second motion vector may be generated based on the reordering methods (such as reordering method, e.g., no reordering, horizontal flip or vertical flip) of the current block and neighboring block.
      i. In one example, suppose the current block is doing IBC AMVP with horizontal flipping, motion vectors of horizontal flipping coded neighboring blocks may be refined/adjusted for constructing the motion vector predictor list.
         1. Additionally, alternatively, motion vectors of vertical flipping and/or no reordering coded neighboring blocks may be not refined/adjusted for constructing the motion vector predictor list.
      ii. In one example, suppose the current block is doing IBC AMVP with vertical flipping, motion vectors of vertical flipping coded neighboring blocks may be refined/adjusted for constructing the motion vector predictor list.
         1. Additionally, alternatively, motion vectors of horizontal flipping and/or no reordering coded neighboring blocks may be not refined/adjusted for constructing the motion vector predictor list.
   g. For example, the second motion vector may be generated based on the coding information of the neighboring block.
   h. For example, the neighbor block may be left, left-bottom, above, above-right, above-left neighboring to the current block.
   i. For example, the second motion vector may be generated based on the prediction mode (such as whether it is coded by MODE_IBC) of the neighboring block.
   j. For example, the second motion vector may be generated based on the block dimension (such as block width, and/or height) of the neighboring block.
   k. For example, the second motion vector may be generated based on the reordering method (such as reordering method, e.g., no reordering, horizontal flip or vertical flip) of the neighboring block.
   l. For example, the second motion vector may be generated based on the location of the neighboring block relative to the current block (e.g., left, or left-bottom, or above, or above-right, or above-left neighboring to the current block).
   m. For example, the second motion vector may be generated based on the coordinates of positions of the current block or the neighbouring block (such as a center point or the top-left point).
   n. For example, the second motion vector may be generated based on adding a shift factor to the first motion vector.
      i. For example, the shift factor may be with the same precision as the first motion vector.
      ii. For example, the shift factor may be generated based on the block dimension (such as block width, and/or height) of the current block.
      iii. For example, the shift factor may be generated based on a fixed/predefined number (such as 4 or 8 or 2 which may be the granularity of the spatial motion vector storage unit).
   o. For example, the second motion vector may be different from the first motion vector.
   p. For example, an example of current motion vector (block vector) adjustment is shown in FIG. 15, wherein W1 denotes the width of the current block, W2 denotes the width of left neighbor block of the current block, leftMV denotes the motion vector (block vector) of the left neighbor block, curMV denotes the motion vector (block vector) of the current block. Therefore, for example the left neighbor block is coded with horizontal flip as shown in the figure, instead of directly inherit the leftMV to the curMV, the horizontal component of curMV may be calculated as curMVx=leftMVx−(W2<<precFactor)−(W1<<precFactor).
      i. For example, precFactor may be a value (such as 0 or 4 or 6), based on the precision difference between MV/BV precision and integer precision.
      ii. For example, W2 may be equal to a value (such as W2=4 or 2 or 8 which may be the granularity of the spatial motion vector storage unit).
      iii. Furthermore, the left neighbor block may be a prior coded block on the left side (adjacent, or non-adjacent) of the current block.
      iv. Furthermore, the left neighbor block may be located at the left-bottom of the current block.
   q. For example, an example of current motion vector (block vector) adjustment is shown in FIG. 17, wherein H1 denotes the height of the current block, H2 denotes the height of above neighbor block of the current block, aboveMV denotes the motion vector (block vector) of the above neighbor block, curMV denotes the motion vector (block vector) of the current block. Therefore, in case that the above neighbor block is coded with vertical flip as shown in the figure, instead of directly inherit the aboveMV to the curMV, the vertical component of curMV may be calculated as curMVy=aboveMVy−(H2<<precFactor)−(H1<<precFactor).
      i. For example, precFactor may be a value (such as 0 or 4 or 6), based on the precision difference between MV/BV precision and integer precision.
      ii. For example, H2 may be equal to a value (such as H2=4 or 2 or 8 which may be the granularity of the spatial motion vector storage unit).
      iii. Furthermore, the above neighbor block may be a prior coded block on the above side (adjacent, or non-adjacent) of the current block.
      iv. Furthermore, the above neighbor block may be located at the above-right of the current block.
b. Suppose a first motion vector is obtained for a sample reordering coded video unit (e.g., current block) based on a neighbor block's coding information, a second motion vector may be generated to refine/adjust the first motion vector. Whether to adjust/refine the first motion vector to the second motion vector, may be dependent on whether the hypothetic second motion vector meet certain rules.
   a. For example, if at least one rule is not satisfied, the hypothetic second motion vector may not be used.
      i. For example, the second motion vector may be discarded.
      ii. For example, both the first and second motion vectors may be discarded.
      iii. For example, the first motion vector without adjustment/refinement may be used.
      iv. For example, the second motion vector may be set equal to the first motion vector.
   b. For example, if all rules are satisfied, the hypothetic second motion vector may be used as the second motion vector.
   c. For example, the rules may contain at least one of the followings:
      i. the reference block pointed by the hypothetic second motion vector is inside the valid area (wherein the valid area may be a pre-defined prior coded region).
      ii. the reference block pointed by the hypothetic second motion vector is inside the current picture.
      iii. the reference block pointed by the hypothetic second motion vector is in the same CTU row of the video unit.
      iv. the reference block pointed by the hypothetic second motion vector is in the same tile of the video unit.
      v. the reference block pointed by the hypothetic second motion vector is in the same CTU or the left CTU of the video unit.
      vi. the reference block pointed by the hypothetic second motion vector is within already coded area.
c. For example, two examples of current motion vector (block vector) adjustment is shown in FIG. 18 and FIG. 19, wherein (x₁, y₁) and (x₂, y₂) represent the coordinates of center points of the neighbouring block and the current block, respectively, (W₁, H₁) and (W₂, H₂) denotes the width and height of left neighbouring block and the current block, BV denotes the motion vector (block vector) of the left neighbouring block, BV′ denotes the motion vector (block vector) of the current block, and (x′₁, y′₁) and (x′₂, y′₂) represent the coordinates of top-left point of the neighbouring block and the current block, respectively.
   a. For example, (x₁, y₁) and (x₂, y₂) may be derived as

$$\begin{matrix}1. & \\ {{{x}_{1} = x ’}_{1} + {W}_{1} / 2 + sx and {y}_{1} = y ’}_{1} + {H}_{1} / 2 + sy . & \end{matrix}$$

$$\begin{matrix}2. & \\ {{{x}_{2} = x ’}_{2} + {W}_{2} / 2 + sx and {y}_{2} = y ’}_{2} + {W}_{1} / 2 + sy . & \end{matrix}$$

wherein sx and sy are offsets such as 0, 1, −1.
   b. The MV (BV) adjustment/refinement method may depend on how sample reordering is performed.
      i. In one example, for a horizontal flip, BV′ₓ=2(x₁−x₂)+BVₓ, and/or BV′_{y}=BV_{y}, as shown in FIG. 18.
      ii. In one example, for a vertical flip, BV′_{y}=2(y₁−y₂)+BV_{y}, and/or BV′ₓ=BVₓ as shown in FIG. 19.
   c. Furthermore, the BV may be with integer precision.
   d. Additionally, the BVs may indicate fractional precision domain MVs, therefore,
      i. In one example, for a horizontal flip, MV′ₓ=((2(x₁−x₂))<<precFactor)+MVₓ
      ii. In one example, for a vertical flip, MV′_{y}=((2(y₁−y₂))<<precFactor)+MV_{y}
         Wherein precFactor may be a value (such as 0 or 4 or 6), based on the precision difference between MV precision and integer precision.
d. In one example, the neighbouring block disclosed in the document may be adjacent to the current block or non-adjacent to the current block.
e. In one example, the information of a neighbouring block disclosed in the document may be stored in a table (such as history-based motion vector prediction, HMVP table) and the information may be fetched from the table to perform the MV adjustment.
   a. For example, the information may comprise:
      i. Motion information (MV and/or BV and/or reference picture and/or inter prediction).
      ii. The coordinate of center point.
      iii. The coordinate of top-left point.
      iv. The width and/or height.
      v. The sample reordering type (such as no reordering, vertical flip and/or horizontal flip).
f. The refined/adjusted MV/BV may be clipped to a range.

### General Claims

5.1.5 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
5.1.6 Whether to and/or how to apply the disclosed methods above may be signalled at PB/TB/CB/PU/TU/CU/VPDU/CTU/CTU row/slice/tile/sub-picture/other kinds of region contain more than one sample or pixel.
5.1.7 Whether to and/or how to apply the disclosed methods above may be dependent on coded information, such as block size, colour format, single/dual tree partitioning, colour component, slice/picture type.

### 5.2 on Motion Constraint, AMVR Signalling, Template Matching, and Sample Reordering_v1

The detailed inventions below should be considered as examples to explain general concepts. These inventions should not be interpreted in a narrow way. Furthermore, these inventions can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
5.2.1 About the motion constraints for coding tools (e.g., the 1st problem and related issues), the following methods are proposed:
a. Motion vector of a video unit coded with a certain prediction method may be constrained by a certain rule.
   a. The motion vector may refer to one or more items as followings:
      i. motion vector difference
      ii. motion vector
      iii. motion vector predictor
   b. The prediction method may refer to one or more items as followings:
      i. IBC AMVP mode
      ii. IBC merge mode
      iii. IBC merge mode with template matching
      iv. Intra template matching
      v. Sample reordering based IBC AMVP mode
      vi. Sample reordering based IBC merge mode
      vii. Sample reordering based IBC merge mode with template matching
      viii. Sample reordering based intra template matching
   c. The rule may refer to one or more items as followings:
      i. The horizontal component of motion vectors may be required to be equal to zero.
      ii. The vertical component of motion vectors may be required to be equal to zero.
b. For example, given that a video unit is coded with IBC AMVP mode, the horizontal component of motion vectors may be required to be equal to zero.
   a. Alternatively, given that a video unit is coded with IBC AMVP mode, the vertical component of motion vectors may be required to be equal to zero.
   b. Furthermore, the IBC AMVP mode in the disclosed bullet may be replaced by IBC merge mode.
   c. Furthermore, the IBC AMVP mode in the disclosed bullet may be replaced by IBC with template matching mode.
      i. In one example, the template matching may be required to be searched along one direction (either horizontal or vertical).
   d. Furthermore, the IBC AMVP mode in the disclosed bullet may be replaced by intra template matching mode.
      i. In one example, the template matching may be required to be searched along one direction (either horizontal or vertical).
c. For example, given that a video unit is coded with sample reordering based IBC AMVP mode (such as samples are flipping horizontally), the vertical component of motion vectors may be treated/constrained/required to be equal to zero.
   a. For example, given that a video unit is coded with sample reordering based IBC AMVP mode (such as samples are flipping vertically), the horizontal component of motion vectors may be treated/constrained/required to be equal to zero.
   b. Furthermore, the IBC AMVP mode in the disclosed bullet may be replaced by IBC merge mode.
   c. Furthermore, the IBC AMVP mode in the disclosed bullet may be replaced by IBC with template matching mode.
      i. In one example, the template matching may be required to be searched along horizontal direction (vertical component of motion vectors equal to 0) for horizontal flip.
      ii. In one example, the template matching may be required to be searched along vertical direction (horizontal component of motion vectors equal to 0) for vertical flip.
   d. Furthermore, the IBC AMVP mode in the disclosed bullet may be replaced by intra template matching mode.
d. For example, if a certain component of a motion vector (such as MVx or MVy) of a video unit is treated/constrained/required to be equal to zero,
   a. The corresponding component of the motion vector difference (such as MVDx or MVDy) of the video unit may be treated/constrained/required to be equal to zero.
   b. The corresponding component of the motion vector predictor (such as MVPx or MVPy) of the video unit may be treated/constrained/required to be equal to zero.
e. For example, if a certain component of a motion vector difference (such as MVDx or MVDy) of a video unit is treated/constrained/required to be equal to zero,
   a. The corresponding component of a motion vector difference may be not signalled but inferred to be equal to zero.
f. For example, the signaling of motion vector difference (MVD) for a certain video unit may be dependent on the motion constraint applied to the video unit.
   a. For example, the sign of MVDx may be not signalled, given that MVDx of the video unit treated/constrained/required to be equal to zero.
   b. For example, the sign of MVDy may be not signalled, given that MVDy of the video unit treated/constrained/required to be equal to zero.
g. For example, if a first component of a motion vector is treated/constrained/required to be equal to zero, the first component of the corresponding MVD/MVP is treated/constrained/required to be equal to zero.
h. “zero” in the above bullets may be replaced by any other fixed or derived or signaled value.
5.2.2 About the AMVR signalling based on the motion constraint (e.g., the 2nd problem and related issues), the following methods are proposed:
a. For example, the signaling of the resolution of the motion vector difference (e.g., amvr_precision_idx of AMVR) for a certain video unit may be dependent on the motion constraint applied to the video unit.
   a. For example, the video unit may be coded with a kind of AMVP mode.
   b. For example, the video unit may be coded with IBC AMVP.
   c. For example, the video unit may be coded with sample reordering based IBC AMVP.
   d. For example, the video unit may be coded with sample reordering based AMVP mode.
   e. For example, the signalling/presence of the resolution of the motion vector difference (e.g., amvr_precision_idx) may be decoupled from MVDx. For example, the signaling may be only dependent on whether the value of MVDy is equal to zero (instead of checking both MVDx and MVDy), given that MVDx of the video unit treated/constrained/required to be equal to zero.
   f. For example, the signalling/presence of the resolution of the motion vector difference (e.g., amvr_precision_idx) may be decoupled from MVDy. For example, the signaling may be only dependent on whether the value of MVDx is equal to zero (instead of checking both MVDx and MVDy), given that MVDy of the video unit treated/constrained/required to be equal to zero.
   g. For example, if the resolution of the motion vector difference (e.g., amvr_precision_idx) is not signalled for such video unit, it may be inferred to be equal to a certain value (such as 0) indicating a default resolution is used.
      i. For example, the default resolution may be 1-pel precision, in case the video unit is coded based on IBC AMVP mode.
      ii. For example, the default resolution may be 1-pel precision, in case the video unit is coded based on sample reordering based IBC AMVP mode.
   b. For example, the signaling of amvr_precision_idx for IBC AMVP coded block may be changed as follows (taking the syntax structure in the VVC spec as an example), wherein cu_ibc_reorder_type indicates whether and how samples in the IBC AMVP coded block are reordered.

| | |
|---|---|
| ... | |
| else if( CuPredMode[ chType ][ x0 ][ y0 ] = = | |
| MODE_IBC ) { | |
| mvd_coding( x0, y0, 0, 0 ) | |
| if( MaxNumIbcMergeCand > 1 ) | |
| mvp_l0_flag[ x0 ][ y0 ] | ae(v) |
| if( sps_amvr_enabled_flag | |
| ( MvdL0[ x0 ][ y0 ][ 0 ] != 0 \|\| MvdL0[ x0 ][ | |
| y0 ][ 1 ] != 0 && cu_ibc_reorder_type == NO_FLIP) \|\| | |
| (MvdL0[ x0 ][ y0 ][ 1 ] != 0 && cu_ibc_reorder_type == | |
| FLIP_HOR ) \|\| | |
| ( MvdL0[ x0 ][ y0 ][ 0 ] != 0 && cu_ibc_reorder_type == | |
| FLIP_VER ) | |
| ) | |
| amvr_precision_idx[ x0 ][ y0 ] | ae(v) |
| } else { | |
| ... | |

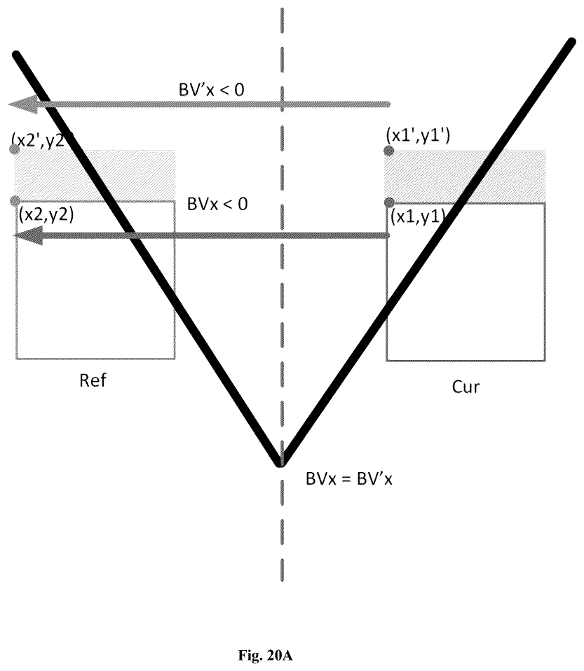

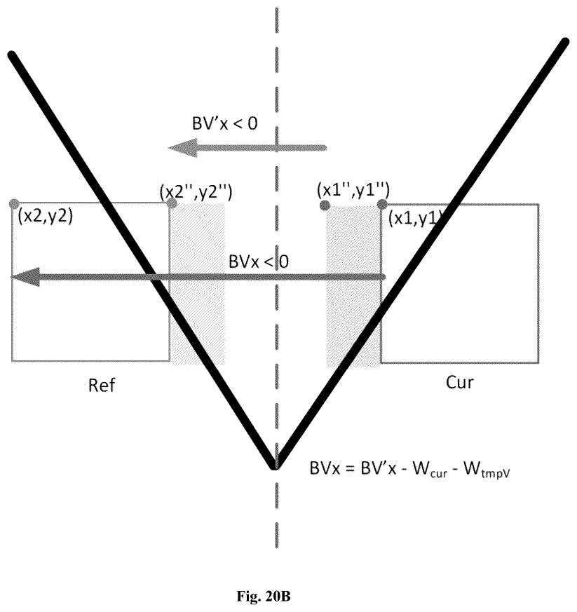

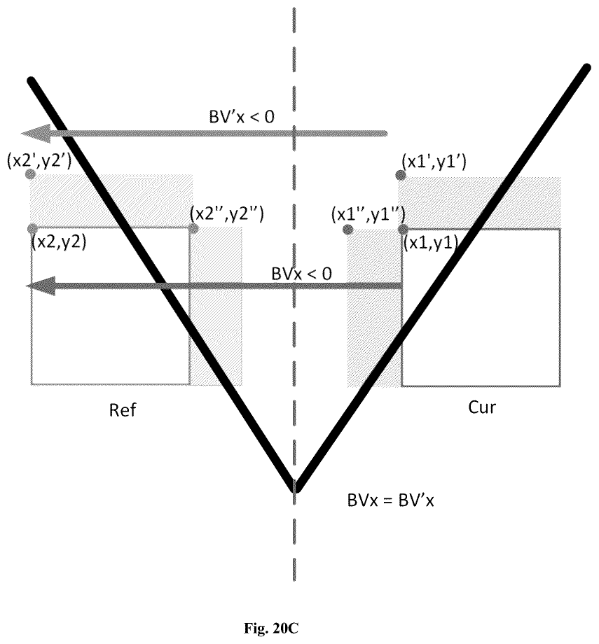

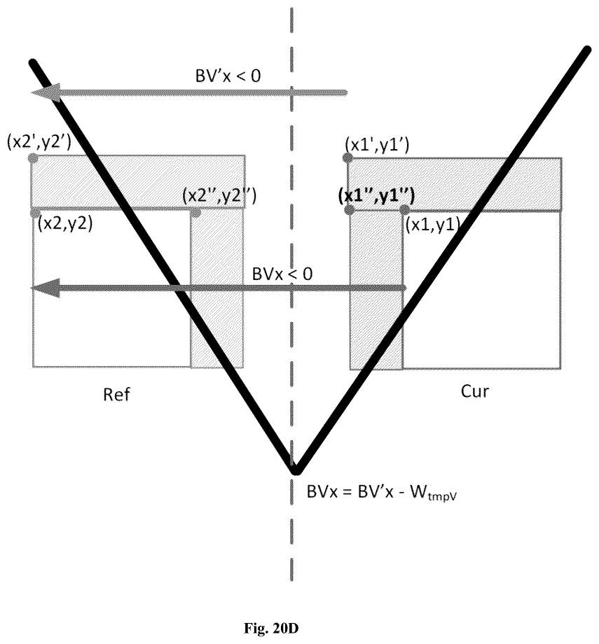

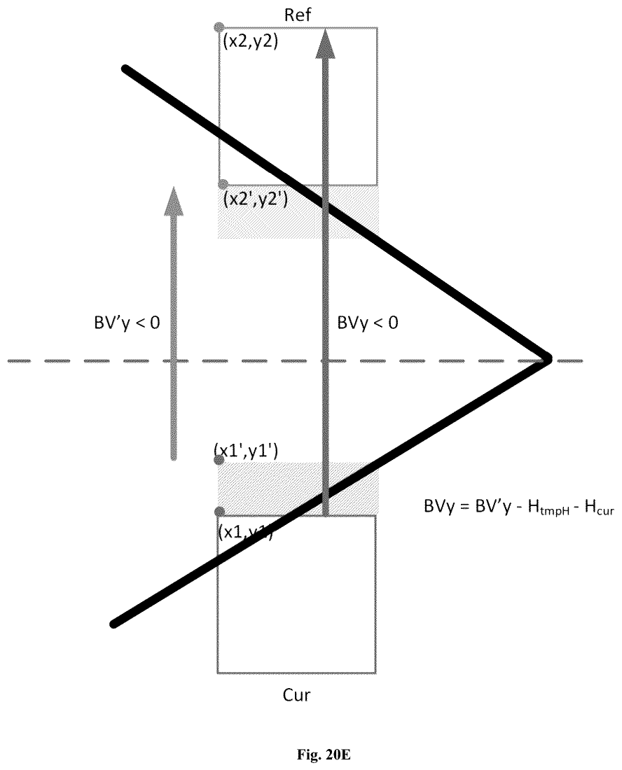

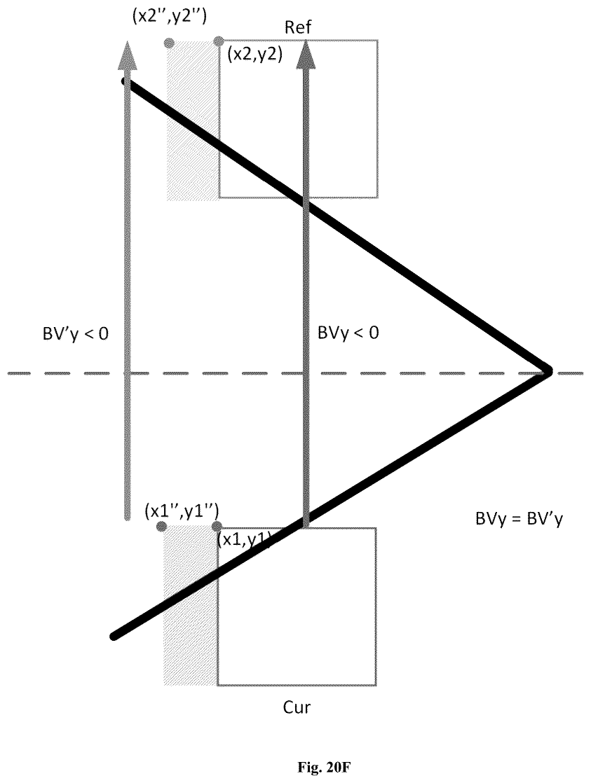

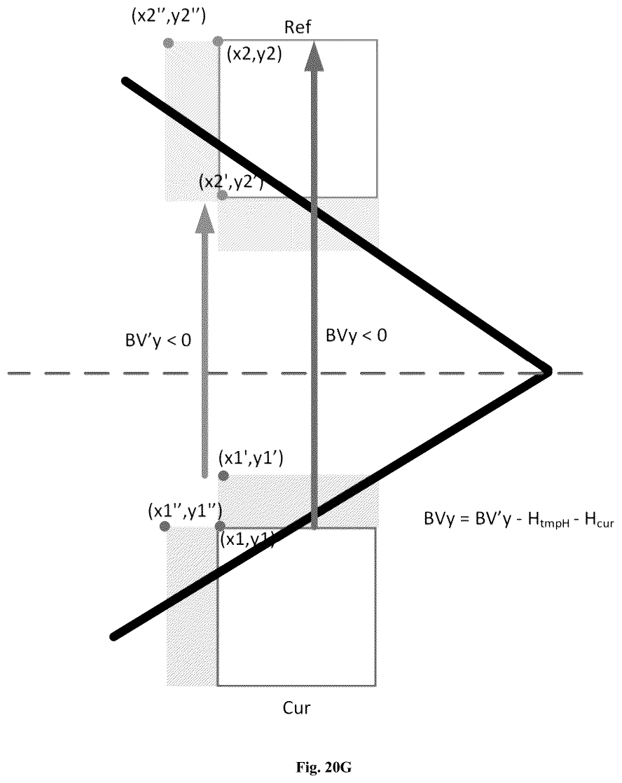

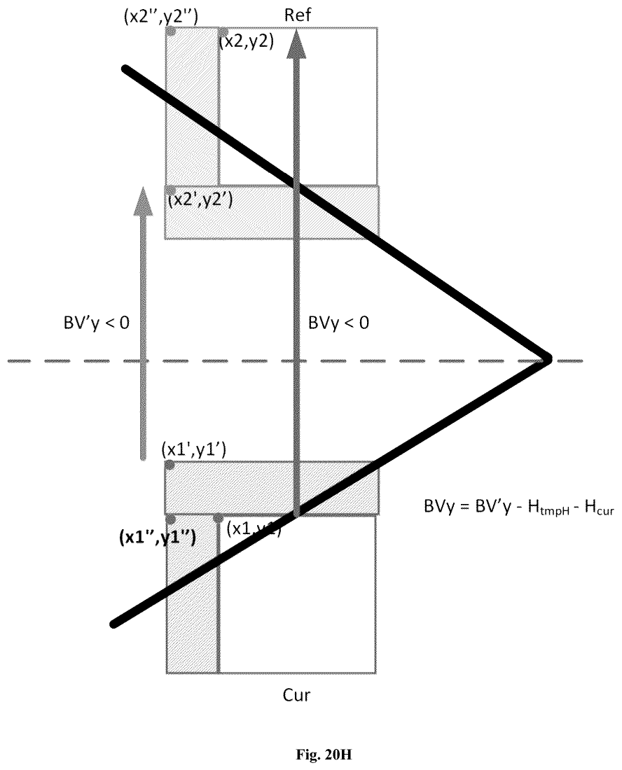

5.2.3 About the template matching (e.g., intra TM, IBC with TM) modification in case of enabling sample reordering (e.g., the 3rd problem and related issues), the following methods are proposed:
   Suppose a first template is used for a first video unit coded with TM with sample reordering, and a second template is used for a second video unit coded with TM without sample reordering:
a. For example, the locations of samples that comprise the template may be dependent on the sample reordering method used to a video unit.
   a. For example, the sample locations of the first template and the second template may be different.
   b. For example, the second template may be constructed with samples above and left to the video unit.
   c. For example, the first template may be constructed with samples above OR left to the video unit.
      i. For example, if the first video unit is coded with horizontal flipping, then the first template may be constructed with samples above to the video unit.
      ii. For example, if the first video unit is coded with vertical flipping, then the first template may be constructed with samples left to the video unit.
   d. Alternatively, the sample locations of the first template and the second template may be same.
b. For example, the number of samples that comprise the template may be dependent on the sample reordering method used to a video unit.
   a. For example, the number of rows and/or columns of the first template and the second template may be different.
   b. For example, the second template may be constructed with M1 rows of samples above and N1 columns of samples left to the video unit, while the first template may be constructed with M2 rows of samples above and/or N2 columns of samples left to the video unit. The following rules may conform:
      i. M1!=M2
      ii. N1!=N2
   c. Alternatively, the number of rows and/or columns of the first template and the second template may be same.
5.2.4 About sample reordering based intra/IBC template matching (e.g., the 4th problem and related issues), the following methods are proposed:
a. How to derive the reference template of a sample reordering coded block may be dependent on coding information.
a. For example, it may be dependent on the sample reordering type and/or the template shape to be used to the current block.
b. The derivation of motion vector (block vector) of a sample reordering coded block may be dependent on coding information.
a. For example, it may be dependent on the sample reordering type and/or the template shape to be used to the current block.
b. For example, it may be dependent on the dimensions (such as width and/or height) of the current block.
c. For example, it may be dependent on the dimensions (such as width and/or height) of the template (or partial template).
d. For example, it may be dependent on the coordinates of positions of the current block or the template (such as a center sample location or the top-left sample location).
   i. For example, the template may be current template and/pr reference template.
c. Eight examples of sample reordering based template matching are shown in FIGS. 20A-20H, wherein the dashed line denotes the flipping is performed across that dashed line (i.e., horizontal dash line indicates vertical flip which means flip upside down, vertical dashed line indicates horizontal flip which means flip left right), blue rectangles denotes current block and current template, orange rectangles denotes reference block and reference template, BV′x and BV′y denote the horizontal and vertical displacement between the current template and the reference template, respectively, BVx and BVy denote the horizontal and vertical displacement between the current block and the reference block, respectively, (W_{cur}, H_{cur}) denotes the width and height of current block, (W_{tmpH}, H_{tmpH}) denotes the width and height of the horizontal template along the block width direction, (W_{tmpV}, H_{tmpV}) denotes the width and height of the vertical template along the block height direction, (x1, y1) and (x2, y2) represent the coordinates of top-left sample of the current block and the reference block, respectively, (x1′, y1′) and (x2′, y2′) represent the coordinates of top-left sample of the current horizontal template and the reference horizontal template, respectively, (x1″, y1″) and (x2″, y2″) represent the coordinates of top-left sample of the current vertical template and the reference vertical template, respectively
a. For example, in case of horizontal template and horizontal flip (i.e., FIG. 20A),
   i. In one example, both the current template and reference template may comprises neighboring samples above to the current block.
   ii. In one example, the relative location of (current block, current template) and the relative location of (reference block, reference template) may be same.
      1. In one example, x1−x1′=x2−x2′, and y1−y1′=y2−y2′
      2. In one example, x1−x1′=0, and y1−y1′=H_{tmpH}
   iii. In one example, either the samples in the current template or the samples in the reference template may be flipped.
   iv. In one example, the samples in the current template may be flipped according to the flip type being checked (e.g., horizontal flip).
   v. In one example, the samples in the reference template may be flipped according to the flip type being checked (e.g., horizontal flip).
   vi. In one example, BVx=BV′x
   vii. In one example, x1′−x2′=x1−x2
b. For example, in case of vertical template and horizontal flip (i.e., FIG. 20B),
   i. In one example, the current template may comprises neighboring samples left to the current block, and the reference template may comprises neighboring samples right to the current block.
   ii. In one example, the relative location of (current block, current template) and the relative location of (reference block, reference template) may be different
      1. In one example, x1−x1″!=x2−x2″, and y1−y1″=y2−y2″
      2. In one example, x1−x1″=W_{tmpV}, and y1−y1″=0
      3. In one example, x2−x2″=−W_{cur}, and y2−y2″=0
   iii. In one example, either the samples in the current template or the samples in the reference template may be flipped.
   iv. In one example, the samples in the current template may be flipped according to the flip type being checked (e.g., horizontal flip).
   v. In one example, the samples in the reference template may be flipped according to the flip type being checked (e.g., horizontal flip).
   vi. In one example, BVₓ=BV′ₓ−W_{cur}−W_{tmpV}
   vii. In one example, x2″−x1″−W_{cur}−W_{tmpV}=x2−x1
c. For example, in case of horizontal-vertical template (wherein W_{tmpH}=W_{cur}) and horizontal flip (i.e., FIG. 20C),
   i. In one example, the current template may comprises neighboring samples above and left to the current block, and the reference template may comprises neighboring samples above and right to the current block.
   ii. In one example, the relative location of (current block, current horizontal template) and the relative location of (reference block, reference horizontal template) may be same.
      1. In one example, x1−x1′=x2−x2′, and y1−y1′=y2−y2′
      2. In one example, x1−x1′=0, and y1−y1′=H_{tmpH}
   iii. In one example, the relative location of (current block, current vertical template) and the relative location of (reference block, reference vertical template) may be not same.
      1. In one example, x1−x1″!=x2−x2″, and y1−y1″=y2−y2″
      2. In one example, x1−x1″=W_{tmpV}, and y1−y1″=0
      3. In one example, x2−x2″=−W_{cur}, and y2−y2″=0
   iv. In one example, either the samples in the current horizontal template or the samples in the reference horizontal template may be flipped.
      1. Furthermore, either the samples in the current vertical template or the samples in the reference vertical template may be flipped.
   v. In one example, the samples in the current horizontal and vertical template may be flipped according to the flip type being checked (e.g., horizontal flip).
   vi. In one example, the samples in the reference horizontal and vertical template may be flipped according to the flip type being checked (e.g., horizontal flip).
   vii. In one example, BVₓ=BV′ₓ
   viii. In one example, x1′−x2′=x1−x2
d. For example, in case of horizontal-vertical template (wherein W_{tmpH}=W_{cur}+W_{tmpV}) and horizontal flip (i.e., FIG. 20D),
   i. In one example, the current template may comprises neighboring samples above and left to the current block, and the reference template may comprises neighboring samples above and right to the current block.
   ii. In one example, the relative location of (current block, current horizontal template) and the relative location of (reference block, reference horizontal template) may be not same.
      1. In one example, x1−x1′!=x2−x2′, and y1−y1′=y2−y2′
      2. In one example, x1−x1′=W_{tmpV}, and y1−y1′=H_{tmpH}
      3. In one example, x2−x2′=0, and y2−y2′=H_{tmpH}
   iii. In one example, the relative location of (current block, current vertical template) and the relative location of (reference block, reference vertical template) may be not same.
      1. In one example, x1−x1″!=x2−x2″, and y1−y1″=y2−y2″
      2. In one example, x1−x1″=W_{tmpV}, and y1−y1″=0
      3. In one example, x2−x2″=−W_{cur}, and y2−y2″=0
   iv. In one example, either the samples in the current horizontal template or the samples in the reference horizontal template may be flipped.
      1. Furthermore, either the samples in the current vertical template or the samples in the reference vertical template may be flipped.
   v. In one example, the samples in the current horizontal and vertical template may be flipped according to the flip type being checked (e.g., horizontal flip).
   vi. In one example, the samples in the reference horizontal and vertical template may be flipped according to the flip type being checked (e.g., horizontal flip).
   vii. In one example, BVₓ=BV′ₓ−W_{tmpV}
   viii. In one example, x2′−x1′−W_{tmpV}=x2−x1
e. For example, in case of horizontal template and vertical flip (i.e., FIG. 20E),
   i. In one example, the current template may comprises neighboring samples above to the current block, and the reference template may comprises neighboring samples below to the current block.
   ii. In one example, the relative location of (current block, current template) and the relative location of (reference block, reference template) may be not same.
      1. In one example, x1−x1′=x2−x2′, and y1−y1′!=y2−y2′
      2. In one example, x1−x1′=0, and y1−y1′=H_{tmpH}
      3. In one example, x2−x2′=0, and y2−y2′=−H_{cur}
   iii. In one example, either the samples in the current template or the samples in the reference template may be flipped.
   iv. In one example, the samples in the current template may be flipped according to the flip type being checked (e.g., vertical flip).
   v. In one example, the samples in the reference template may be flipped according to the flip type being checked (e.g., vertical flip).
   vi. In one example, BVy=BV′y−H_{tmpH}−H_{cur}
   vii. In one example, y2′−y1′−H_{tmpH}−H_{cur}=y2−y1
f. For example, in case of vertical template and vertical flip (i.e., FIG. 20F),
   i. In one example, both the current template and the reference template may comprises neighboring samples left to the current block.
   ii. In one example, the relative location of (current block, current template) and the relative location of (reference block, reference template) may be same
      1. In one example, x1−x1″=x2−x2″, and y1−y1″=y2−y2″
      2. In one example, x1−x1″=W_{tmpV}, and y1−y1″=0
   iii. In one example, either the samples in the current template or the samples in the reference template may be flipped.
   iv. In one example, the samples in the current template may be flipped according to the flip type being checked (e.g., vertical flip).
   v. In one example, the samples in the reference template may be flipped according to the flip type being checked (e.g., vertical flip).
   vi. In one example, BVy=BV′y
   vii. In one example, y1″−y2″=y1−y2
g. For example, in case of horizontal-vertical template (wherein W_{tmpH}=W_{cur}) and vertical flip (i.e., FIG. 20G),
   i. In one example, the current template may comprises neighboring samples above and left to the current block, and the reference template may comprises neighboring samples left and below to the current block.
   ii. In one example, the relative location of (current block, current horizontal template) and the relative location of (reference block, reference horizontal template) may be not same.
      1. In one example, x1−x1′=x2−x2′, and y1−y1′!=y2−y2′
      2. In one example, x1−x1′=0, and y1−y1′=H_{tmpH}
      3. In one example, x2−x2′=0, and y2−y2′=−H_{cur}
   iii. In one example, the relative location of (current block, current vertical template) and the relative location of (reference block, reference vertical template) may be same.
      1. In one example, x1−x1″=x2−x2″, and y1−y1″=y2−y2″
      2. In one example, x1−x1″=W_{tmpV}, and y1−y1″=0
   iv. In one example, either the samples in the current horizontal template or the samples in the reference horizontal template may be flipped.
      1. Furthermore, either the samples in the current vertical template or the samples in the reference vertical template may be flipped.
   v. In one example, the samples in the current horizontal and vertical template may be flipped according to the flip type being checked (e.g., vertical flip).
   vi. In one example, the samples in the reference horizontal and vertical template may be flipped according to the flip type being checked (e.g., vertical flip).
   vii. In one example, BVy=BV′y−H_{tmpH}−H_{cur}
   viii. In one example, y2′−y1′−H_{tmpH}−H_{cur}=y2−y1
h. For example, in case of horizontal-vertical template (wherein W_{tmpH}=W_{cur}+W_{tmpV}) and vertical flip (i.e., FIG. 20H),
   i. In one example, the current template may comprises neighboring samples above and left to the current block, and the reference template may comprises neighboring samples left and below to the current block.
   ii. In one example, the relative location of (current block, current horizontal template) and the relative location of (reference block, reference horizontal template) may be not same.
      1. In one example, x1−x1′=x2−x2′, and y1−y1′!=y2−y2′
      2. In one example, x1−x1′=W_{tmpV}, and y1−y1′=H_{tmpH}
      3. In one example, x2−x2′=W_{tmpV}, and y2−y2′=−H_{cur}
   iii. In one example, the relative location of (current block, current vertical template) and the relative location of (reference block, reference vertical template) may be same.
      1. In one example, x1−x1″=x2−x2″, and y1−y1″=y2−y2″
      2. In one example, x1−x1″=W_{tmpV}, and y1−y1″=0
   iv. In one example, either the samples in the current horizontal template or the samples in the reference horizontal template may be flipped.
      1. Furthermore, either the samples in the current vertical template or the samples in the reference vertical template may be flipped.
   v. In one example, the samples in the current horizontal and vertical template may be flipped according to the flip type being checked (e.g., vertical flip).
   vi. In one example, the samples in the reference horizontal and vertical template may be flipped according to the flip type being checked (e.g., vertical flip).
   vii. In one example, BVy=BV′y−H_{tmpH}−H_{cur}
   viii. In one example, y2′−y1′−H_{tmpH}−H_{cur}=y2−y1
5.2.5 About the motion search with template matching when sampling reordering method is applied, (e.g., the 5th problem and related issues), the following methods are proposed:
a. In one example, for a sample reordering method (such as vertical flip or horizontal flip) samples in the template around the current block may be reordered before being compared with samples (which are not reordered) in the template around the reference block to get a cost.
b. In one example, for a sample reordering method (such as vertical flip or horizontal flip) samples in the template around the reference block may be reordered before being compared with samples (which are not reordered) in the template around the current block to get a cost.
c. In one example, for a sample reordering method (such as vertical flip or horizontal flip) samples in both the template around the reference block and the template around the current block may be reordered before being compared to get a cost.
5.2.6 About how to determine the sampling reordering method (such as no flip, vertical flip or horizontal flip) for a template matching (such as intra template matching, and/or IBC mode with template matching) coded block (e.g., the 6th problem and related issues), the following methods are proposed:
a. In one example, the sampling reordering method may depend on at least one syntax element signaled from the encoder to the decoder.
   i. In one example, the syntax element may indicate whether to and/or how to reorder samples for a template matching coded block (such as intra template matching, and/or IBC mode with template matching, etc.).
   ii. The syntax element may be coded with the same manner as that used to indicate whether to and/or how to reorder samples for a certain prediction method (such as IBC) coded block.
b. In one example, the sampling reordering method may be derived based on at least one template cost.
   i. In one example, motion search with template matching with different sampling reordering methods may be applied for a block, to derive the minimum costs for different sampling reordering methods
   ii. In one example, the sampling reordering method with the smallest template cost may be derived as the determined sampling reordering method.

### General Aspects

5.2.7 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
5.2.8 Whether to and/or how to apply the disclosed methods above may be signalled at PB/TB/CB/PU/TU/CU/VPDU/CTU/CTU row/slice/tile/sub-picture/other kinds of region contain more than one sample or pixel.
5.2.9 Whether to and/or how to apply the disclosed methods above may be dependent on coded information, such as block size, colour format, single/dual tree partitioning, colour component, slice/picture type.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “image compression” may represent any variance of signal processing methods that compress or process the current input. The input images/videos include but not limited to the screen content and natural content.

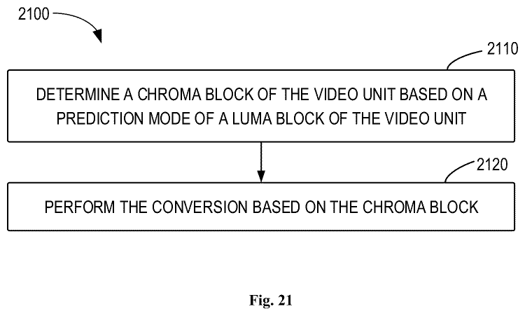

FIG. 21 illustrates a flowchart of a method 2100 for video processing in accordance with embodiments of the present disclosure. The method 2100 is implemented during a conversion between a video unit of a video and a bitstream of the video.

At block 2110, for a conversion between a video unit of a video and a bitstream of the video, a chroma block of the video unit is determined based on a prediction mode of a luma block of the video unit. In some embodiments, if an intra template matching prediction mode is applied, the luma block and the chroma block of the video unit share a block vector. In some embodiments, if the intra template matching prediction mode is applied to the luma block, the chroma block derive a chroma prediction based on a block vector that is determined from the luma block.

At block 2120, the conversion is performed based on the chroma block. In this way, the coding efficiency of the block vector coding can be improved. In some embodiments, the conversion may include encoding the video unit into the bitstream. Alternatively, or in addition, the conversion may include decoding the video unit from the bitstream.

In some embodiments, the luma block and the chroma block utilize a same sample reordering approach. For example, the sample reordering approach may be one of: no flip, horizontal flip, or vertical flip.

In some embodiments, if the sample reordering approach is applied to the luma block, the chroma block performs the sample reordering approach same as the luma block. In some embodiments, the luma block is coded as an intra template matching based sample reordering.

In some embodiments, if the luma block is coded with a sample reordering approach, the chroma block is coded with a prediction approach that is different from the sample reordering approach of the luma block.

In some embodiments, the chroma block is coded with a kind of chroma intra mode and the luma block is coded with a sample reordering approach. In some embodiments, the chroma block is coded with a kind of chroma intra mode, and the luma block is coded with a sample reordering based intra template matching approach. For example, the kind of chroma intra mode comprises one of: a derived mode (DM) mode, a planar mode, a direct currency (DC) mode, or a cross-component linear model (CCLM) mode. Alternatively, or in addition, the sample reordering approach comprises one of: a no flip approach, a horizontal flip approach, or a vertical flip approach.

In some embodiments, whether the chroma block is determined based on the prediction mode of the luma block is dependent on whether at least one of: a dual tree or a local dual tree is applied. In some other embodiments, the chroma block is determined based on the prediction mode of the luma block, regardless of whether at least one of: a dual tree or a local dual tree is applied.

In some embodiments, if a luma component of the video unit is coded based on a target coding approach, a sample reordering approach is applied to the luma component. In some embodiments, the target coding approach is based on an intra template matching.

In some embodiments, an indication of whether to and/or how to determine the chroma block based on the prediction mode of the luma block is indicated at one of the followings: sequence level, group of pictures level, picture level, slice level, or tile group level. In some embodiments, an indication of whether to and/or how to determine the chroma block based on the prediction mode of the luma block is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to determine the chroma block based on the prediction mode of the luma block is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2100 further comprises: determining, based on coded information of the video unit, whether and/or how to determine the chroma block based on the prediction mode of the luma block. In this case, the coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a chroma block of a video unit of the video based on a prediction mode of a luma block of the video unit; and generating a bitstream based on the chroma block.

According to still further embodiments of the present disclosure, a method for storing bitstream of a video is provided. The method comprises: determining a chroma block of a video unit of the video based on a prediction mode of a luma block of the video unit; generating a bitstream based on the chroma block; and storing the bitstream in a non-transitory computer-readable recording medium.

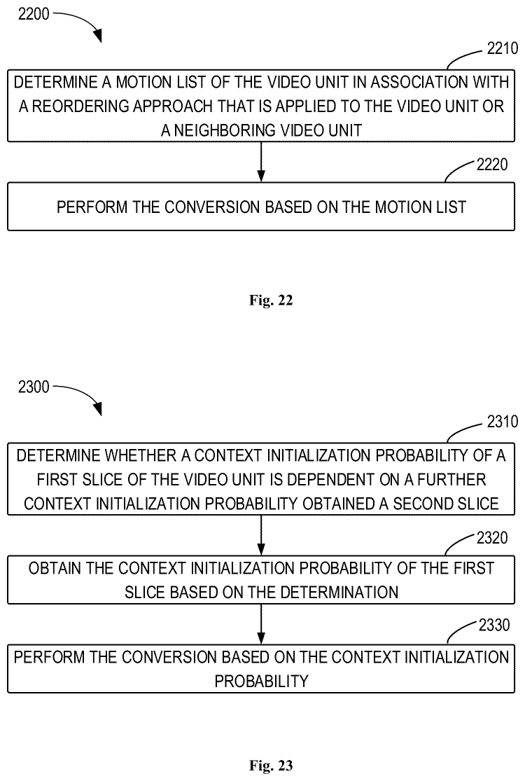

FIG. 22 illustrates a flowchart of a method 2200 for video processing in accordance with embodiments of the present disclosure. The method 2200 is implemented during a conversion between a video unit of a video and a bitstream of the video.

At block 2210, for a conversion between a video unit of a video and a bitstream of the video, a motion list of the video unit is generated in association with a reordering approach that is applied to the video unit or a neighboring video unit. The neighboring video is coded prior to the video unit. For example, the motion list is generated considering the reordering approach.

At block 2220, the conversion is performed based on the motion list. In some embodiments, the conversion may include encoding the video unit into the bitstream. Alternatively, or in addition, the conversion may include decoding the video unit from the bitstream. In this way, the coding efficiency of the block vector coding can be improved.

In some embodiments, the reordering approach of the neighboring video unit is checked for the generation of the motion list. In some embodiments, the reordering approach of the video unit is checked for the generation of the motion list.

In some embodiments, if the neighboring video unit is coded with a sample reordering approach, a motion derived from the neighboring video unit is adjusted for the generation of the motion list of the video unit. In one example, as long as the first block (e.g., a neighbor block) is coded with a sample reordering method, the motion derived from the first block may be adjusted (e.g., by adding a motion shift or a delta MV) for the motion list construction of the target block. The first block may refer to a neighbor block coded prior to the current block and the target block may be the current block being coded.

In some embodiments, if the video unit is coded with a sample reordering approach, a motion derived from the neighboring video unit is adjusted for the generation of the motion list of the video unit. In some embodiments, if a reordering approach of the neighboring video unit and a reordering approach of the video unit are same, a motion derived from the neighboring video unit is adjusted for the generation of the motion list of the video unit. In one example, as long as the target block (e.g., the current block) is coded with a sample reordering method, the motion derived from the first block may be adjusted (e.g., by adding a motion shift or a delta MV) for the motion list construction of the target block. In some embodiments, the motion is adjusted by one of: adding a motion shift or adding a delta motion vector.

In some embodiments, if a reordering approach of the neighboring video unit and a reordering approach of the video unit are same, a motion list of the neighboring video unit is inserted to the motion list of the video unit. For example, the reordering method of a first block (e.g., a neighbor block) and the reordering method of the target block (e.g., the current block) are same (e.g., both are coded with no sample reordering, or horizontal flip, or vertical flip, etc.). For example, the motion the first block (and/or its variant) may be inserted to the motion list of the target block. For example, the motion derived from the first block may be adjusted (e.g., by adding a motion shift or a delta MV) for the motion list construction of the target block.

In some embodiments, at least one new motion candidate is added to the motion list of the video unit. In some embodiments, the at least one new motion candidate is generated based on a motion adjustment, according to the reordering approach. For example, the new motion candidate may be generated based on motion adjustment (e.g., by adding a motion shift or a delta MV), considering the reordering method.

In some embodiments, the at least one new motion candidate is required to have a same reordering approach as the neighboring video unit. For example, the new motion candidate may be required to have the same reordering method (e.g., no reorder, horizontal flip, vertical flip, and etc.) as the target block.

In some embodiments, the at least one new motion candidate is not required to have a same reordering approach as the neighboring video unit. For example, the new motion candidate may not necessarily have the same reordering method (e.g., no reorder, horizontal flip, vertical flip, and etc.) as the target block.

In some embodiments, the at least one motion candidate is generated based on a motion of an adjacent neighboring video unit of the video unit. In some embodiments, the at least one motion candidate is generated based on a motion of a non-adjacent neighboring video unit of the video unit.

In some embodiments, the at least one motion candidate is generated based on a motion from a certain buffer. For example, the certain buffer comprises one or more of: a look-up table, or a history-based motion vector predictor (HMVP) table.

In some embodiments, if the motion list is not fulfilled, the at least one new motion candidate is added to the motion list. For example, the above described embodiments may be applied when the motion list is not fulfilled, for example, the length of the motion list is less than a pre-defined value.

In some embodiments, the motion list is at least one of: a block vector list of an intra block copy (IBC) coded video unit, or a motion vector list of the IBC coded video unit. In some embodiments, the IBC coded video unit is IBC advanced motion vector predictor (AMVP) coded. Alternatively, the IBC coded video unit is IBC merge coded. In some embodiments, the motion list is used for a coding mode different from IBC.

In some embodiments, a sorting of motion candidate indexes is dependent on at least one of: a sample reordering approach used to the neighboring video unit, or a sample reordering approach used to the video unit. For example, the motion candidate indexes sorting (e.g., ARMC) may be dependent on the sample reordering method used to neighbor blocks and/or the sample reordering method used to the target block (e.g., current block).

In some embodiments, motion candidates are grouped dependent on the sample reordering approach. In some embodiments, a motion candidate derived from the neighboring video unit that is sample reordering coded is put at front of the motion list. In some other embodiments, a motion candidate derived from the neighboring video unit that is sample reordering coded is put at end of the motion list.

In some embodiments, a first motion candidate derived from a non-sample-reordering coded neighboring video unit is put after a second motion candidate derived from a sample reordering coded neighboring video unit. In some other embodiments, a first motion candidate derived from a non-sample-reordering coded neighboring video unit is put before a second motion candidate derived from a sample reordering coded neighboring video unit.

In some embodiments, motion candidates derived from neighboring video units coded with a first coding approach is regarded as a first group for the sorting, and motion candidates from neighboring video units coded with a second coding approach is regarded as a second group for the sorting. For example, the motion candidates derived from neighboring blocks coded with a first coding method may be treated as a first group for candidate index sorting (e.g., ARMC), while the motion candidates derived from neighboring blocks coded with a second coding method may be treated as a second group for candidate index sorting (e.g., ARMC).

In some embodiments, the first coding approach refers to any type of sample reordering approaches. For example, the first coding method may be referred to all kinds of sample reordering methods (e.g., any types of horizontal flip, vertical flip, etc.).

In some embodiments, the first coding approach refers to a certain type of sample reordering approach. For example, the certain type of sample reordering approach may include one of: horizontal flip, or vertical flip. In some embodiments, the first coding approach refers to the sample reordering approach same as the video unit.

In some embodiments, the second coding approach refers to a non-sample reordering approach. In some embodiments, the second coding approach refers to a certain type of sample reordering approach. For example, the certain type of sample reordering approach may include one of: horizontal flip, or vertical flip.

In some embodiments, motion candidates derived from neighboring video units coded with a same sample reordering approach are treated as one group for the sorting. In some embodiments, only motion candidates derived from neighboring video units coded with a sample reordering approach is applicable for the sorting.

In some embodiments, only motion candidates derived from neighboring video units with a certain type of sample reordering approach is applicable for the sorting. In some embodiments, only motion candidates derived from neighboring video units coded with a non-sample-reordering approach is applicable for the sorting. In some embodiments, only if motion candidates derived from neighboring video units coded with a same sample reordering approach as the video unit, the motion candidates are sorted.

In some embodiments, the video unit is coded with at least one of: an IBC AMVP mode, or a variant of IBC AMVP mode. For example, the above-described embodiments may be used in case that the target block is coded with IBC AMVP (and/or its variant).

In some embodiments, the video unit is coded with an AMVP mode that is different from IBC AMVP mode. Alternatively, the claimed rule may be used in case that the target block is coded an AMVP mode different from IBC AMVP.

In some embodiments, the video unit is coded with at least one of: an IBC merge mode, or a variant of IBC merge mode. For example, the claimed rule may be used in case that the target block is coded IBC merge (and/or its variant).

In some embodiments, the video unit is coded with a merge mode that is different from IBC merge mode. For example, the above-described embodiments may be used in case that the target block is coded with a merge mode different from IBC merge.

In some embodiments, the neighboring video unit is coded with a sample reordering approach. For example, the above-described embodiments may be used in case that the first block is coded with a sample reordering method.

In some embodiments, the neighboring video unit is not coded with a sample reordering approach. For example, the above-described embodiments may be used in case that the first block is not coded with sample reordering.

In some embodiments, the motion list of the video unit is generated in association with the reordering approach that is applied to the video unit or the neighboring video unit, regardless of a sampling reordering approach of the neighboring video unit. For example, the above-described embodiments may be used regardless of the sample reordering method of the first block.

In some embodiments, the video unit is coded with a sample reordering approach. For example, the above-described embodiments may be used in case that the target block is coded with a sample reordering method.

In some embodiments, the video unit is not coded with a sample reordering approach. For example, the above-described embodiments may be used in case that the target block is not coded with sample reordering.

In some embodiments, the motion list of the video unit is generated in association with the reordering approach that is applied to the video unit or the neighboring video unit, regardless of a sampling reordering approach of the video unit. For example, the above-described embodiments may be used regardless of the sample reordering method of the target block.

In some embodiments, an indication of whether to and/or how to generate the motion list in association with the reordering approach is indicated at one of the followings: sequence level, group of pictures level, picture level, slice level, or tile group level. In some embodiments, an indication of whether to and/or how to generate the motion list in association with the reordering approach is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to generate the motion list in association with the reordering approach is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2200 further comprises: determining, based on coded information of the video unit, whether and/or how to generate the motion list in association with the reordering approach. In this case, the coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: generating a motion list of a video unit of the video in association with a reordering approach that is applied to the video unit or a neighboring video unit, and wherein the neighboring video is coded prior to the video unit; and generating a bitstream based on the motion list.

According to still further embodiments of the present disclosure, a method for storing bitstream of a video is provided. The method comprises: generating a motion list of a video unit of the video in association with a reordering approach that is applied to the video unit or a neighboring video unit, and wherein the neighboring video is coded prior to the video unit; generating a bitstream based on the motion list; and storing the bitstream in a non-transitory computer-readable recording medium.

FIG. 23 illustrates a flowchart of a method 2300 for video processing in accordance with embodiments of the present disclosure. The method 2300 is implemented during a conversion between a video unit of a video and a bitstream of the video.

At block 2310, for a conversion between a video unit of a video and a bitstream of the video, it is determined that whether a context initialization probability of a first slice of the video unit is dependent on a further context initialization probability obtained a second slice.

At block 2320, the context initialization probability of the first slice is obtained based on the determination. In some embodiments, the context initialization probability of the first slice is not dependent on the further context initialization probability that is obtained from the second slice in a different picture. In some embodiments, the context initialization probability of the first slice is dependent on the further context initialization probability that is obtained from the second slice, and an indication of the second slice is indicated in the first slice. In some embodiments, the context initialization probability of the first slice is dependent on the further context initialization probability that is obtained from the second slice, and the second slice is a reference slice of the first slice.

At block 2330, the conversion is performed based on the context initialization probability. In some embodiments, the conversion may include encoding the video unit into the bitstream. Alternatively, or in addition, the conversion may include decoding the video unit from the bitstream. In this way, the coding efficiency of the block vector coding can be improved.

In some embodiments, an indication of whether to and/or how to obtain the context initialization probability of the first slice based on the determination is indicated at one of the followings: sequence level, group of pictures level, picture level, slice level, or tile group level. In some embodiments, an indication of whether to and/or how to obtain the context initialization probability of the first slice based on the determination is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to obtain the context initialization probability of the first slice based on the determination is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2300 further comprises: determining, based on coded information of the video unit, whether and/or how to obtain the context initialization probability of the first slice based on the determination. In this case, the coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining whether a context initialization probability of a first slice of a video unit of the video is dependent on a further context initialization probability obtained a second slice; obtaining the context initialization probability of the first slice based on the determination; and generating the bitstream based on the context initialization probability.

According to still further embodiments of the present disclosure, a method for storing bitstream of a video is provided. The method comprises: determining whether a context initialization probability of a first slice of a video unit of the video is dependent on a further context initialization probability obtained a second slice; obtaining the context initialization probability of the first slice based on the determination; generating the bitstream based on the context initialization probability; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, a chroma block of the video unit based on a prediction mode of a luma block of the video unit; and performing the conversion based on the chroma block.

Clause 2. The method of clause 1, wherein if an intra template matching prediction mode is applied, the luma block and the chroma block of the video unit share a block vector.

Clause 3. The method of clause 2, wherein if the intra template matching prediction mode is applied to the luma block, the chroma block derive a chroma prediction based on a block vector that is determined from the luma block.

Clause 4. The method of clause 1, wherein the luma block and the chroma block utilize a same sample reordering approach.

Clause 5. The method of clause 4, wherein if the sample reordering approach is applied to the luma block, the chroma block performs the sample reordering approach same as the luma block.

Clause 6. The method of clause 4, wherein the luma block is coded as an intra template matching based sample reordering.

Clause 7. The method of clause 1, wherein if the luma block is coded with a sample reordering approach, the chroma block is coded with a prediction approach that is different from the sample reordering approach of the luma block.

Clause 8. The method of clause 7, wherein the chroma block is coded with a kind of chroma intra mode and the luma block is coded with a sample reordering approach.

Clause 9. The method of clause 7, wherein the chroma block is coded with a kind of chroma intra mode, and the luma block is coded with a sample reordering based intra template matching approach.

Clause 10. The method of clause 8 or 9, wherein the kind of chroma intra mode comprises one of: a derived mode (DM) mode, a planar mode, a direct currency (DC) mode, or a cross-component linear model (CCLM) mode, and wherein the sample reordering approach comprises one of: a no flip approach, a horizontal flip approach, or a vertical flip approach.

Clause 11. The method of clause 1, wherein whether the chroma block is determined based on the prediction mode of the luma block is dependent on whether at least one of: a dual tree or a local dual tree is applied.

Clause 12. The method of clause 1, wherein the chroma block is determined based on the prediction mode of the luma block, regardless of whether at least one of: a dual tree or a local dual tree is applied.

Clause 13. The method of clause 1, wherein if a luma component of the video unit is coded based on a target coding approach, a sample reordering approach is applied to the luma component.

Clause 14. The method of clause 13, wherein the target coding approach is based on an intra template matching.

Clause 15. The method of any of clauses 1-14, wherein an indication of whether to and/or how to determine the chroma block based on the prediction mode of the luma block is indicated at one of the followings: sequence level, group of pictures level, picture level, slice level, or tile group level.

Clause 16. The method of any of clauses 1-14, wherein an indication of whether to and/or how to determine the chroma block based on the prediction mode of the luma block is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 17. The method of any of clauses 1-14, wherein an indication of whether to and/or how to determine the chroma block based on the prediction mode of the luma block is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 18. The method of any of clauses 1-14, further comprising: determining, based on coded information of the video unit, whether and/or how to determine the chroma block based on the prediction mode of the luma block, the coded information including at least one of: a block size, a colour format, a single and/or dual tree partitioning, a colour component, a slice type, or a picture type.

Clause 19. A method of video processing, comprising: generating, for a conversion between a video unit of a video and a bitstream of the video, a motion list of the video unit in association with a reordering approach that is applied to the video unit or a neighboring video unit, wherein the neighboring video is coded prior to the video unit; and performing the conversion based on the motion list.

Clause 20. The method of clause 19, wherein the reordering approach of the neighboring video unit is checked for the generation of the motion list.

Clause 21. The method of clause 19, wherein the reordering approach of the video unit is checked for the generation of the motion list.

Clause 22. The method of clause 19, wherein if the neighboring video unit is coded with a sample reordering approach, a motion derived from the neighboring video unit is adjusted for the generation of the motion list of the video unit.

Clause 23. The method of clause 19, wherein if the video unit is coded with a sample reordering approach, a motion derived from the neighboring video unit is adjusted for the generation of the motion list of the video unit.

Clause 24. The method of clause 19, wherein if a reordering approach of the neighboring video unit and a reordering approach of the video unit are same, a motion derived from the neighboring video unit is adjusted for the generation of the motion list of the video unit.

Clause 25. The method of any of clauses 22-24, wherein the motion is adjusted by one of: adding a motion shift or adding a delta motion vector.

Clause 26. The method of clause 19, wherein if a reordering approach of the neighboring video unit and a reordering approach of the video unit are same, a motion list of the neighboring video unit is inserted to the motion list of the video unit.

Clause 27. The method of clause 19, wherein at least one new motion candidate is added to the motion list of the video unit.

Clause 28. The method of clause 27, wherein the at least one new motion candidate is generated based on a motion adjustment, according to the reordering approach.

Clause 29. The method of clause 27, wherein the at least one new motion candidate is required to have a same reordering approach as the neighboring video unit.

Clause 30. The method of clause 27, wherein the at least one new motion candidate is not required to have a same reordering approach as the neighboring video unit.

Clause 31. The method of clause 27, wherein the at least one motion candidate is generated based on a motion of an adjacent neighboring video unit of the video unit.

Clause 32. The method of clause 27, wherein the at least one motion candidate is generated based on a motion of a non-adjacent neighboring video unit of the video unit.

Clause 33. The method of clause 27, wherein the at least one motion candidate is generated based on a motion from a certain buffer.

Clause 34. The method of clause 33, wherein the certain buffer comprises one or more of: a look-up table, or a history-based motion vector predictor (HMVP) table.

Clause 35. The method of clause 27, wherein if the motion list is not fulfilled, the at least one new motion candidate is added to the motion list.

Clause 36. The method of clause 19, wherein the motion list is at least one of: a block vector list of an intra block copy (IBC) coded video unit, or a motion vector list of the IBC coded video unit.

Clause 37. The method of clause 36, wherein the IBC coded video unit is IBC advanced motion vector predictor (AMVP) coded, or wherein the IBC coded video unit is IBC merge coded.

Clause 38. The method of clause 19, wherein the motion list is used for a coding mode different from IBC.

Clause 39. The method of clause 19, wherein a sorting of motion candidate indexes is dependent on at least one of: a sample reordering approach used to the neighboring video unit, or a sample reordering approach used to the video unit.

Clause 40. The method of clause 39, wherein motion candidates are grouped dependent on the sample reordering.

Clause 41. The method of clause 39, wherein a motion candidate derived from the neighboring video unit that is sample reordering coded is put at front of the motion list.

Clause 42. The method of clause 39, wherein a motion candidate derived from the neighboring video unit that is sample reordering coded is put at end of the motion list.

Clause 43. The method of clause 39, wherein a first motion candidate derived from a non-sample-reordering coded neighboring video unit is put after a second motion candidate derived from a sample reordering coded neighboring video unit.

Clause 44. The method of clause 39, wherein a first motion candidate derived from a non-sample-reordering coded neighboring video unit is put before a second motion candidate derived from a sample reordering coded neighboring video unit.

Clause 45. The method of clause 39, wherein motion candidates derived from neighboring video units coded with a first coding approach is regarded as a first group for the sorting, and motion candidates from neighboring video units coded with a second coding approach is regarded as a second group for the sorting.

Clause 46. The method of clause 45, wherein the first coding approach refers to any type of sample reordering approaches.

Clause 47. The method of clause 45, wherein the first coding approach refers to a certain type of sample reordering approach.

Clause 48. The method of clause 45, wherein the first coding approach refers to the sample reordering approach same as the video unit.

Clause 49. The method of clause 45, wherein the second coding approach refers to a non-sample reordering approach.

Clause 50. The method of clause 45, wherein the second coding approach refers to a certain type of sample reordering approach.

Clause 51. The method of clause 39, wherein motion candidates derived from neighboring video units coded with a same sample reordering approach are treated as one group for the sorting.

Clause 52. The method of clause 39, wherein only motion candidates derived from neighboring video units coded with a sample reordering approach is applicable for the sorting.

Clause 53. The method of clause 39, wherein only motion candidates derived from neighboring video units with a certain type of sample reordering approach is applicable for the sorting.

Clause 54. The method of clause 39, wherein only motion candidates derived from neighboring video units coded with a non-sample-reordering approach is applicable for the sorting.

Clause 55. The method of clause 39, wherein only if motion candidates derived from neighboring video units coded with a same sample reordering approach as the video unit, the motion candidates are sorted.

Clause 56. The method of any of clauses 19-55, wherein the video unit is coded with at least one of: an IBC AMVP mode, or a variant of IBC AMVP mode.

Clause 57. The method of any of clauses 19-55, wherein the video unit is coded with an AMVP mode that is different from IBC AMVP mode.

Clause 58. The method of any of clauses 19-55, wherein the video unit is coded with at least one of: an IBC merge mode, or a variant of IBC merge mode.

Clause 59. The method of any of clauses 19-55, wherein the video unit is coded with a merge mode that is different from IBC merge mode.

Clause 60. The method of any of clauses 19-55, wherein the neighboring video unit is coded with a sample reordering approach.

Clause 61. The method of any of clauses 19-55, wherein the neighboring video unit is not coded with a sample reordering approach.

Clause 62. The method of any of clauses 19-55, wherein the motion list of the video unit is generated in association with the reordering approach that is applied to the video unit or the neighboring video unit, regardless of a sampling reordering approach of the neighboring video unit.

Clause 63. The method of any of clauses 19-55, wherein the video unit is coded with a sample reordering approach.

Clause 64. The method of any of clauses 19-55, wherein the video unit is not coded with a sample reordering approach.

Clause 65. The method of any of clauses 19-55, wherein the motion list of the video unit is generated in association with the reordering approach that is applied to the video unit or the neighboring video unit, regardless of a sampling reordering approach of the video unit.

Clause 66. The method of any of clauses 19-65, wherein an indication of whether to and/or how to generate the motion list in association with the reordering approach is indicated at one of the followings: sequence level, group of pictures level, picture level, slice level, or tile group level.

Clause 67. The method of any of clauses 19-65, wherein an indication of whether to and/or how to generate the motion list in association with the reordering approach is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 68. The method of any of clauses 19-65, wherein an indication of whether to and/or how to generate the motion list in association with the reordering approach is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 69. The method of any of clauses 19-65, further comprising: determining, based on coded information of the video unit, whether and/or how to generate the motion list in association with the reordering approach, the coded information including at least one of: a block size, a colour format, a single and/or dual tree partitioning, a colour component, a slice type, or a picture type.

Clause 70. A method of video processing, comprising: determining, for a conversion between a video unit of a video and a bitstream of the video, whether a context initialization probability of a first slice of the video unit is dependent on a further context initialization probability obtained a second slice; obtaining the context initialization probability of the first slice based on the determination; and performing the conversion based on the context initialization probability.

Clause 71. The method of clause 70, wherein the context initialization probability of the first slice is not dependent on the further context initialization probability that is obtained from the second slice in a different picture.

Clause 72. The method of clause 70, wherein the context initialization probability of the first slice is dependent on the further context initialization probability that is obtained from the second slice, and an indication of the second slice is indicated in the first slice.

Clause 73. The method of clause 70, wherein the context initialization probability of the first slice is dependent on the further context initialization probability that is obtained from the second slice, and the second slice is a reference slice of the first slice.

Clause 74. The method of any of clauses 70-73, wherein an indication of whether to and/or how to obtain the context initialization probability of the first slice based on the determination is indicated at one of the followings: sequence level, group of pictures level, picture level, slice level, or tile group level.

Clause 75. The method of any of clauses 70-73, wherein an indication of whether to and/or how to obtain the context initialization probability of the first slice based on the determination is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 76. The method of any of clauses 70-73, wherein an indication of whether to and/or how to obtain the context initialization probability of the first slice based on the determination is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 77. The method of any of clauses 70-73, further comprising: determining, based on coded information of the video unit, whether and/or how to obtain the context initialization probability of the first slice based on the determination, the coded information including at least one of: a block size, a colour format, a single and/or dual tree partitioning, a colour component, a slice type, or a picture type.

Clause 78. The method of any of clauses 1-77, wherein the conversion includes encoding the video unit into the bitstream.

Clause 79. The method of any of clauses 1-77, wherein the conversion includes decoding the video unit from the bitstream.

Clause 80. An apparatus for video processing comprising a processor and a non-transitory memory with instructions thereon, wherein the instructions upon execution by the processor, cause the processor to perform a method in accordance with any of clauses 1-18.

Clause 81. A non-transitory computer-readable storage medium storing instructions that cause a processor to perform a method in accordance with any of clauses 1-18.

Clause 82. A non-transitory computer-readable recording medium storing a bitstream of a video which is generated by a method performed by an apparatus for video processing, wherein the method comprises: determining a chroma block of a video unit of the video based on a prediction mode of a luma block of the video unit; and generating a bitstream based on the chroma block.

Clause 83. A method for storing a bitstream of a video, comprising: determining a chroma block of a video unit of the video based on a prediction mode of a luma block of the video unit; generating a bitstream based on the chroma block; and storing the bitstream in a non-transitory computer-readable recording medium.

Clause 84. A non-transitory computer-readable recording medium storing a bitstream of a video which is generated by a method performed by an apparatus for video processing, wherein the method comprises: generating a motion list of a video unit of the video in association with a reordering approach that is applied to the video unit or a neighboring video unit, and wherein the neighboring video is coded prior to the video unit; and generating a bitstream based on the motion list.

Clause 85. A method for storing a bitstream of a video, comprising: generating a motion list of a video unit of the video in association with a reordering approach that is applied to the video unit or a neighboring video unit, and wherein the neighboring video is coded prior to the video unit; generating a bitstream based on the motion list; and storing the bitstream in a non-transitory computer-readable recording medium.

Clause 86. A non-transitory computer-readable recording medium storing a bitstream of a video which is generated by a method performed by an apparatus for video processing, wherein the method comprises: determining whether a context initialization probability of a first slice of a video unit of the video is dependent on a further context initialization probability obtained a second slice; obtaining the context initialization probability of the first slice based on the determination; and generating the bitstream based on the context initialization probability.

Clause 87. A method for storing a bitstream of a video, comprising determining whether a context initialization probability of a first slice of a video unit of the video is dependent on a further context initialization probability obtained a second slice; obtaining the context initialization probability of the first slice based on the determination; generating the bitstream based on the context initialization probability; and storing the bitstream in a non-transitory computer-readable recording medium.

### Example Device

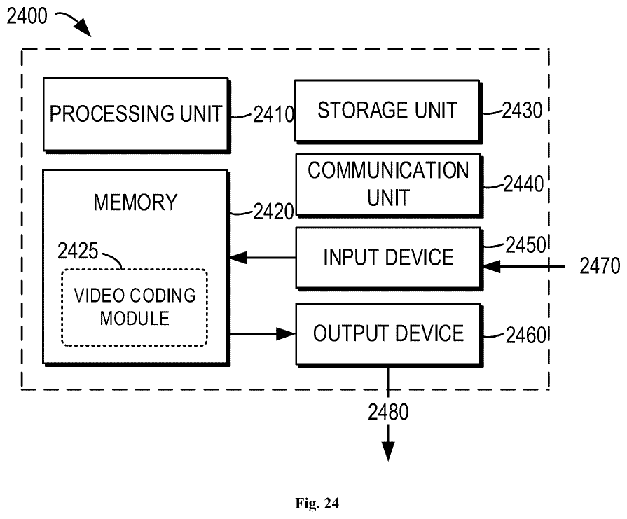

FIG. 24 illustrates a block diagram of a computing device 2400 in which various embodiments of the present disclosure can be implemented. The computing device 2400 may be implemented as or included in the source device 110 (or the video encoder 114 or 200) or the destination device 120 (or the video decoder 124 or 300).

It would be appreciated that the computing device 2400 shown in FIG. 24 is merely for purpose of illustration, without suggesting any limitation to the functions and scopes of the embodiments of the present disclosure in any manner.

As shown in FIG. 24, the computing device 2400 includes a general-purpose computing device 2400. The computing device 2400 may at least comprise one or more processors or processing units 2410, a memory 2420, a storage unit 2430, one or more communication units 2440, one or more input devices 2450, and one or more output devices 2460.

In some embodiments, the computing device 2400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2400 can support any type of interface to a user (such as “wearable” circuitry and the like).

The processing unit 2410 may be a physical or virtual processor and can implement various processes based on programs stored in the memory 2420. In a multi-processor system, multiple processing units execute computer executable instructions in parallel so as to improve the parallel processing capability of the computing device 2400. The processing unit 2410 may also be referred to as a central processing unit (CPU), a microprocessor, a controller or a microcontroller.

The computing device 2400 typically includes various computer storage medium. Such medium can be any medium accessible by the computing device 2400, including, but not limited to, volatile and non-volatile medium, or detachable and non-detachable medium. The memory 2420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2430 may be any detachable or non-detachable medium and may include a machine-readable medium such as a memory, flash memory drive, magnetic disk or another other media, which can be used for storing information and/or data and can be accessed in the computing device 2400.

The computing device 2400 may further include additional detachable/non-detachable, volatile/non-volatile memory medium. Although not shown in FIG. 24, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2440 communicates with a further computing device via the communication medium. In addition, the functions of the components in the computing device 2400 can be implemented by a single computing cluster or multiple computing machines that can communicate via communication connections. Therefore, the computing device 2400 can operate in a networked environment using a logical connection with one or more other servers, networked personal computers (PCs) or further general network nodes.

The input device 2450 may be one or more of a variety of input devices, such as a mouse, keyboard, tracking ball, voice-input device, and the like. The output device 2460 may be one or more of a variety of output devices, such as a display, loudspeaker, printer, and the like. By means of the communication unit 2440, the computing device 2400 can further communicate with one or more external devices (not shown) such as the storage devices and display device, with one or more devices enabling the user to interact with the computing device 2400, or any devices (such as a network card, a modem and the like) enabling the computing device 2400 to communicate with one or more other computing devices, if required. Such communication can be performed via input/output (I/O) interfaces (not shown).

In some embodiments, instead of being integrated in a single device, some or all components of the computing device 2400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2400 may be used to implement video encoding/decoding in embodiments of the present disclosure. The memory 2420 may include one or more video coding modules 2425 having one or more program instructions. These modules are accessible and executable by the processing unit 2410 to perform the functionalities of the various embodiments described herein.

In the example embodiments of performing video encoding, the input device 2450 may receive video data as an input 2470 to be encoded. The video data may be processed, for example, by the video coding module 2425, to generate an encoded bitstream. The encoded bitstream may be provided via the output device 2460 as an output 2480.

In the example embodiments of performing video decoding, the input device 2450 may receive an encoded bitstream as the input 2470. The encoded bitstream may be processed, for example, by the video coding module 2425, to generate decoded video data. The decoded video data may be provided via the output device 2460 as the output 2480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a chroma block of the video unit based on a prediction mode of a luma block of the video unit; and
performing the conversion based on the chroma block.

2. The method of claim 1, wherein if an intra template matching prediction mode is applied, the luma block and the chroma block of the video unit share a block vector, or
wherein the luma block and the chroma block utilize a same sample reordering approach, or
wherein if the luma block is coded with a sample reordering approach, the chroma block is coded with a prediction approach that is different from the sample reordering approach of the luma block, or
wherein whether the chroma block is determined based on the prediction mode of the luma block is dependent on whether at least one of: a dual tree or a local dual tree is applied.

3. The method of claim 2, wherein if the intra template matching prediction mode is applied to the luma block, the chroma block derive a chroma prediction based on a block vector that is determined from the luma block, or
wherein if the sample reordering approach is applied to the luma block, the chroma block performs the sample reordering approach same as the luma block, or
wherein the luma block is coded as an intra template matching based sample reordering, or
wherein the chroma block is coded with a kind of chroma intra mode and the luma block is coded with a sample reordering approach, or
wherein the chroma block is coded with a kind of chroma intra mode, and the luma block is coded with a sample reordering based intra template matching approach.

4. The method of claim 1, wherein a motion list of the video unit is generated in association with a reordering approach that is applied to the video unit or a neighboring video unit, wherein the neighboring video unit is coded prior to the video unit.

5. The method of claim 4, wherein the reordering approach of the neighboring video unit is checked for the generation of the motion list, or
wherein the reordering approach of the video unit is checked for the generation of the motion list, or
wherein if the neighboring video unit is coded with a sample reordering approach, a motion derived from the neighboring video unit is adjusted for the generation of the motion list of the video unit, or
wherein if the video unit is coded with a sample reordering approach, a motion derived from the neighboring video unit is adjusted for the generation of the motion list of the video unit, or
wherein if a reordering approach of the neighboring video unit and a reordering approach of the video unit are same, a motion derived from the neighboring video unit is adjusted for the generation of the motion list of the video unit.

6. The method of claim 5, wherein the motion is adjusted by one of: adding a motion shift or adding a delta motion vector.

7. The method of claim 4, wherein if a reordering approach of the neighboring video unit and a reordering approach of the video unit are same, a motion list of the neighboring video unit is inserted to the motion list of the video unit.

8. The method of claim 4, wherein at least one new motion candidate is added to the motion list of the video unit.

9. The method of claim 8, wherein the at least one new motion candidate is generated based on a motion adjustment, according to the reordering approach, or
wherein the at least one new motion candidate is required to have a same reordering approach as the neighboring video unit, or
wherein the at least one new motion candidate is not required to have a same reordering approach as the neighboring video unit, or
wherein the at least one motion candidate is generated based on a motion of an adjacent neighboring video unit of the video unit, or
wherein the at least one motion candidate is generated based on a motion of a non-adjacent neighboring video unit of the video unit, or
wherein the at least one motion candidate is generated based on a motion from a certain buffer, or
wherein if the motion list is not fulfilled, the at least one new motion candidate is added to the motion list.

10. The method of claim 9, wherein the certain buffer comprises one or more of: a look-up table, or a history-based motion vector predictor (HMVP) table.

11. The method of claim 4, wherein the motion list is at least one of:
a block vector list of an intra block copy (IBC) coded video unit, or
a motion vector list of the IBC coded video unit.

12. The method of claim 11, wherein the IBC coded video unit is IBC advanced motion vector predictor (AMVP) coded, or
wherein the IBC coded video unit is IBC merge coded.

13. The method of claim 4, wherein the motion list is used for a coding mode different from IBC.

14. The method of claim 4, wherein a sorting of motion candidate indexes is dependent on at least one of:
a sample reordering approach used to the neighboring video unit, or
a sample reordering approach used to the video unit.

15. The method of claim 1, wherein the video unit is coded with at least one of: an IBC AMVP mode, or a variant of IBC AMVP mode, or
wherein the video unit is coded with an AMVP mode that is different from IBC AMVP mode, or
wherein the video unit is coded with at least one of: an IBC merge mode, or a variant of IBC merge mode, or
wherein the video unit is coded with a merge mode that is different from IBC merge mode.

16. The method of claim 1, wherein the conversion includes encoding the video unit into the bitstream.

17. The method of claim 1, wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, a chroma block of the video unit based on a prediction mode of a luma block of the video unit; and
perform the conversion based on the chroma block.

19. A non-transitory computer-readable storage medium storing instructions that cause a processor to:
determine, for a conversion between a video unit of a video and a bitstream of the video, a chroma block of the video unit based on a prediction mode of a luma block of the video unit; and
perform the conversion based on the chroma block.

20. A non-transitory computer-readable recording medium storing a bitstream of a video which is generated by a method performed by an apparatus for video processing, wherein the method comprises:
determining a chroma block of a video unit of the video based on a prediction mode of a luma block of the video unit; and
generating a bitstream based on the chroma block.
